(19) United States
(12) Patent Application Publication
(10) Pub. No.: US 2025/0365408 A1
(43) Pub. Date: Nov. 27, 2025

(54) SIGNALING AND FILTERING OF TEMPLATE AND FLEXIBLE PARTITION SPLIT

(71) Applicant: Tencent America LLC, Palo Alto, CA (US)

(72) Inventors: Roman CHERNYAK, Santa Clara, CA (US); Biao WANG, San Jose, CA (US); Lien-Fei CHEN, Palo Alto, CA (US); Ziyue XIANG, Palo Alto, CA (US); Shan LIU, San Jose, CA (US); Yifan WANG, Palo Alto, CA (US); Yonguk YOON, Palo Alto, CA (US); Motong XU, Palo Alto, CA (US); Tianqi LIU, Palo Alto, CA (US)

(73) Assignee: Tencent America LLC, Palo Alto, CA (US)

(21) Appl. No.: 19/216,658

(22) Filed: May 22, 2025

Related U.S. Application Data
(60) Provisional application No. 63/651,932, filed on May 24, 2024.
(60) Provisional application No. 63/702,436, filed on Oct. 2, 2024.
(60) Provisional application No. 63/702,463, filed on Oct. 2, 2024.
(60) Provisional application No. 63/703,796, filed on Oct. 4, 2024.

(51) Int. Cl. H04N 19/117; H04N 19/107; H04N 19/132; H04N 19/136; H04N 19/172; H04N 19/176; H04N 19/184; H04N 19/82

(52) U.S. Cl. CPC H04N 19/117; H04N 19/107; H04N 19/132; H04N 19/136; H04N 19/172; H04N 19/176; H04N 19/184; H04N 19/82

(57) ABSTRACT

Methods and apparatuses for video decoding and video encoding and methods of processing visual media data are provided. A method for video decoding includes receiving coded information of a current block in a current picture. Whether to apply a filter to a neighboring reconstructed area of the current block is determined. The neighboring reconstructed area is adjacent to the current block and includes reconstructed samples in the current picture. The filter is applied to the neighboring reconstructed area of the current block. The current block is reconstructed according to the filtered neighboring reconstructed area.

### RELATED APPLICATIONS

The present application claims the benefit of priority to U.S. Provisional Application No. 63/651,932, “FLEXIBLE PARTITION SPLIT” filed on May 24, 2024, U.S. Provisional Application No. 63/702,436, “TEMPLATE FILTERING FOR TEMPLATE-BASED INTER PREDICTION” filed on Oct. 2, 2024, U.S. Provisional Application No. 63/702,463, “METHOD AND APPARATUS FOR SIGNALING BASED ON REFERENCE SAMPLES FEATURES” filed on Oct. 2, 2024, and U.S. Provisional Application No. 63/703,796, “ENHANCEMENT OF REFERENCE PIXEL OR TEMPLATE FOR INTRA PREDICTION MODE” filed on Oct. 4, 2024, which are incorporated by reference herein in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure include methods and apparatuses for video encoding/decoding.

Aspects of the disclosure provide a method for video decoding in which coded information of a current block in a current picture is received. Whether to apply a filter to a neighboring reconstructed area of the current block is determined. The neighboring reconstructed area is adjacent to the current block and includes reconstructed samples in the current picture. The filter is applied to the neighboring reconstructed area of the current block. The current block is reconstructed according to the filtered neighboring reconstructed area.

Aspects of the disclosure also provide a method for video encoding in which whether one of (i) a control flag of a prediction mode used to predict a current block in a current picture and (ii) a type of the prediction mode is to be signaled in a video bitstream is determined based on one of partitioning information and prediction information of a neighboring reconstructed area of the current block. The current block is predicted based on reconstructed samples in the neighboring reconstructed area that is adjacent to the current block. The current block is encoded according to the prediction mode and the reconstructed samples in the neighboring reconstructed area. The one of the control flag and the type of the prediction mode is encoded in the video bitstream when the one of the control flag and the type of the prediction mode is determined to be signaled.

Aspects of the disclosure also provide a method for video decoding in which coded information of a current area to be partitioned in a current picture is received. A partition structure of the current area is determined based on one of (i) size information of the current area and (ii) partitioning information of another area. The current area is reconstructed based on the determined partition structure of the current area.

Aspects of the disclosure also provide an apparatus for video decoding. The apparatus for video decoding includes processing circuitry configured to implement any of the described methods for video decoding.

Aspects of the disclosure also provide an apparatus for video encoding. The apparatus for video encoding includes processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of templates in inter prediction according to an aspect of the disclosure.

FIG. 5 shows an example of a current template including neighboring samples of a current block and a reference template including neighboring samples of a corresponding reference block used for deriving local illumination compensation (LIC) parameters according to an aspect of the disclosure.

FIG. 6 shows examples of deblocking filters according to an aspect of the disclosure.

FIG. 7 shows examples of in-loop filters according to an aspect of the disclosure.

FIG. 8 shows an example of a current block in a current picture and a neighboring reconstructed area of the current block according to an aspect of the disclosure.

FIG. 9 shows examples of a neighboring reconstructed area of a current block in a current picture according to an aspect of the disclosure.

FIG. 10 shows an example of a block and a neighboring reconstructed area that is formed by three neighboring blocks of the block according to an aspect of the disclosure.

FIGS. 11-12 show examples of a block and a current template according to an aspect of the disclosure.

FIG. 13 shows an example of a block partitioning structure according to an aspect of the disclosure.

FIG. 14A shows an example of a vertical center-side triple-tree partitioning according to an aspect of the disclosure.

FIG. 14B shows an example of a horizontal center-side triple-tree partitioning according to an aspect of the disclosure.

FIG. 15 shows an example of five partition splits according to an aspect of the disclosure.

FIG. 16 shows an example of a flexible partition split predicted from an above area or a left area of a current area with a partition depth reduced by 1 according to an aspect of the disclosure.

FIGS. 17A-17B show examples of a flexible partition split predicted using directionality of partition information in a neighboring area of a current area according to an aspect of the disclosure.

FIGS. 18A-18G show examples of flexible partitions predicted by extrapolating partition information in a neighboring area of a current area according to an aspect of the disclosure.

FIGS. 19A-19C show an example of modifying a derived flexible partition split using prior information according to an aspect of the disclosure.

FIGS. 20A-20B show examples of scanning orders for a current block (2001) according to an aspect of the disclosure.

FIG. 21 shows a flow chart outlining a process (2100) according to an aspect of the disclosure.

FIG. 22 shows a flow chart outlining a process (2200) according to an aspect of the disclosure.

FIG. 23 shows a flow chart outlining a process (2300) according to an aspect of the disclosure.

FIG. 24 is a schematic illustration of a computer system in accordance with an aspect.

### DETAILED DESCRIPTION

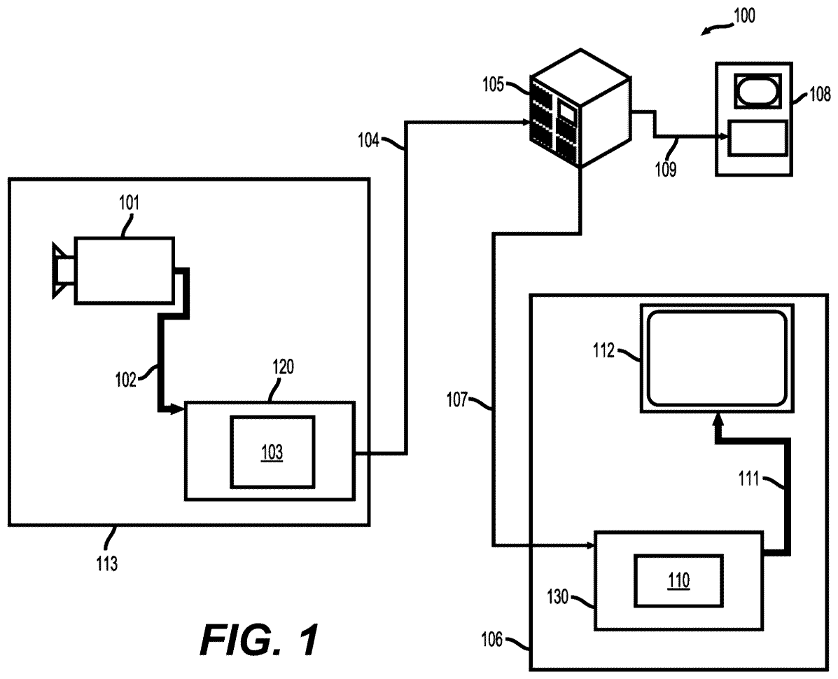

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

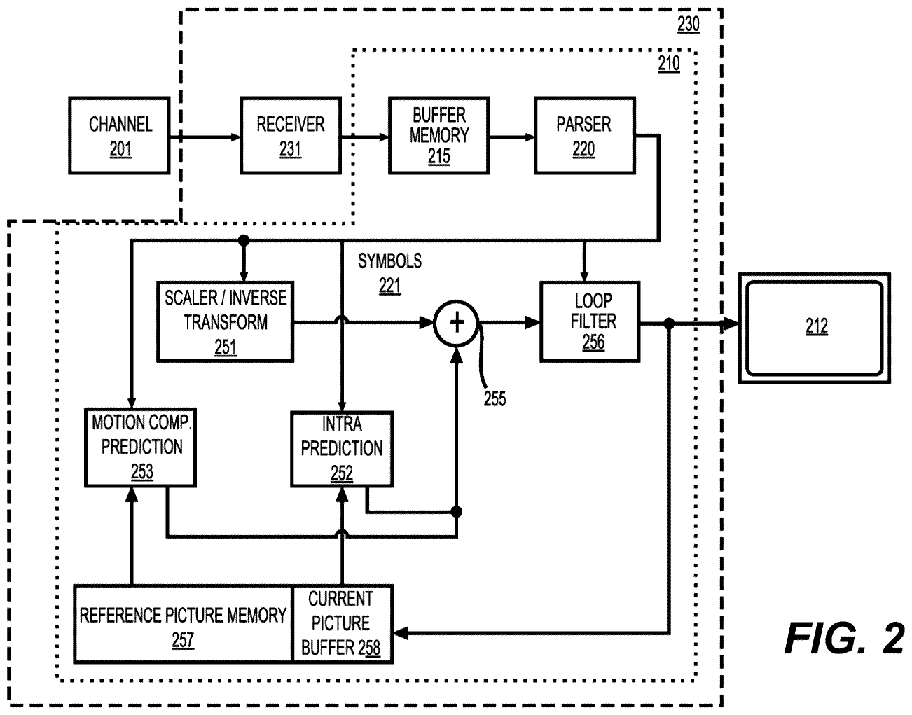

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

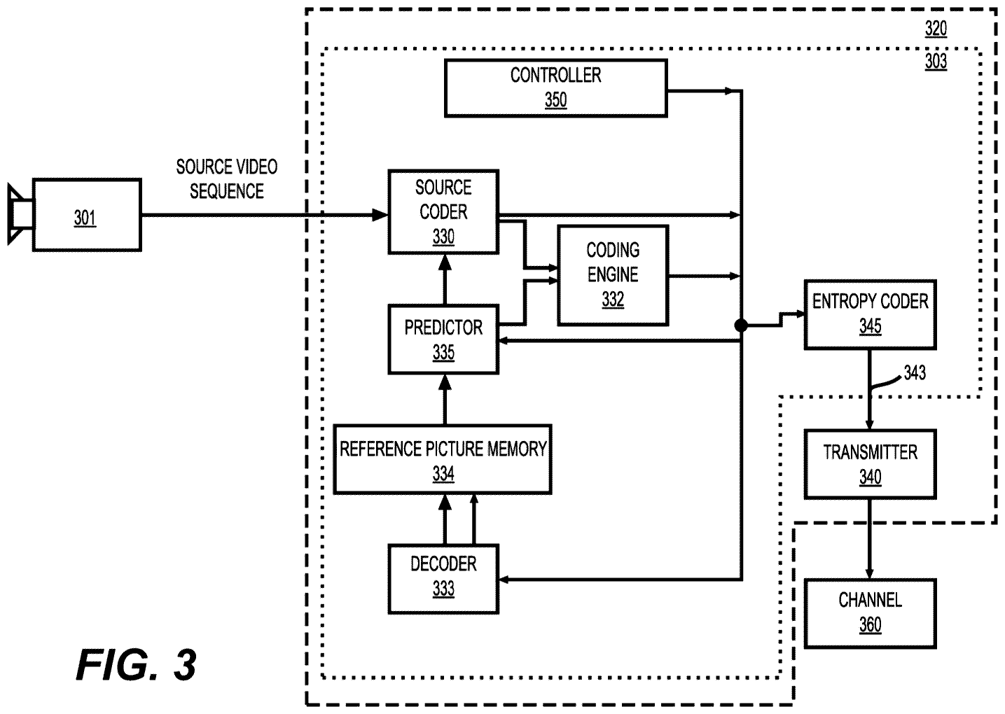

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Video coding has been widely used in many applications such as broadcasting, video recording, video streaming, and the like. Various emerging video coding standards such as H.264, H.265/HEVC, H.266/VVC, and AV1 are adopted in the video applications. A hybrid video codec can include coding modules, intra prediction, inter prediction, transform coding, quantization, entropy coding, in-loop filtering (or in-loop filters), and the like. A set of methods for video compression, including methods related to template matching prediction are disclosed.

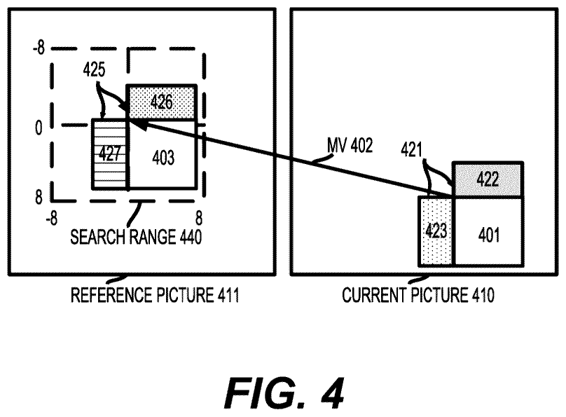

In an example, a template is used in video coding. In an aspect, a template may include a pre-defined area neighboring to a current block, as shown in FIG. 4. Since a template is close to the current block, the template and the current block may be highly correlated. When a reference template (e.g., a best reference template) in a reference frame is found, a reference block corresponding to the reference template may be optimal (e.g., the best). The reference template may be adjacent to the reference block. To find the template (e.g., the best template), a template cost is evaluated. The template cost may be a sum of absolute differences (SAD), a sum of transformed differences (SATD), or other metrics, such as a mean removal SAD (MRSAD) between the reference template and the current template.

The use of templates offers a way for the codec to assess coding information and predict block content with confidence to some extent. FIG. 4 shows an example of templates in inter prediction according to an aspect of the disclosure. In an example, in FIG. 4, a predefined search range (440) is used to find a motion vector (MV) (e.g., an optimal MV) starting from an initial MV. Advantages of the template approach include that the template approach relies on already coded areas, making the templates readily available to both the encoder and decoder without the need for additional data transmission. Consequently, templates may provide an efficient mean of guiding block predictions and enhancing overall coding efficiency.

In FIG. 4, a current block (401) in a current picture (410) is under reconstruction. A current template (421) of the current block (401) may include a top template (422) and a left template (423). An initial MV (402) points to a reference block (403) in a reference picture (411). A search for an MV may be performed in a search range (440). Template costs may be calculated based on the current template (421) and reference templates in the reference picture (411). In an example, the template costs include a template cost between the current template (421) and a reference template (425) which corresponds to the initial MV (402). The reference template (425) includes a top template (426) and a left template (427).

A template is not only used for a template matching process such as the motion vector refinement shown in FIG. 4, but also in other video coding methods, such as local illumination compensation (LIC). LIC may be an inter prediction technique to model a local illumination variation between a current block and a prediction block of the current block. The local illumination variation can be modeled as a function of a local illumination variation between the current block template and a reference block template.

For example, when a motion vector is determined, local illumination compensation is modeled using the formula: p′[x]=α·p[x]+β. p[x] is an original pixel at a position x in a reference template, p′[x] is a compensated pixel at a corresponding position in a current template, and α and β are compensation parameters. The parameters α and β can be determined by using linear regression such that the compensated pixel values in the current template best match the corresponding pixel values in the reference template. The derived mode is then applied to the reference samples to determine the predictor of the current coding block.

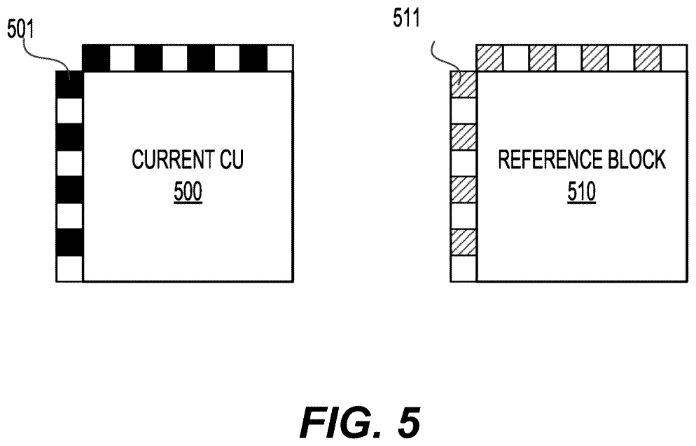

FIG. 5 shows an example of a current template (501) including neighboring samples of a current block (500) and a reference template (511) including neighboring samples of a corresponding reference block (510) used for deriving the LIC parameters a and B.

In an example, when a CU is coded with merge mode, an LIC flag can be copied from one of the neighboring blocks in a way similar to motion information copy in merge mode. In an example, an LIC flag can be signaled for the CU to indicate whether LIC is applied or not.

In an aspect, a template-based inter prediction method may refer to an inter prediction method that predicts a current block based on reconstructed samples in a reconstructed neighboring area (e.g., a current template) of the current block. The reconstructed neighboring area may be a current template of the current block, such as the current template (421) in FIG. 4 or the current template (501) in FIG. 5. In some examples, when applying the template-based inter prediction method, a misalignment arises between the current template and the reference template. In some examples, the misalignment occurs because the current template is constructed using reconstructed samples before in-loop filtering, and the reference template is derived from samples that have already undergone in-loop filtering. For example, the reconstructed samples in the current template are not filtered by the in-loop filtering, and the reconstructed samples in the reference template have been filtered by the in-loop filtering. In some examples, the mismatch between the two templates can undermine the accuracy of the matching process or model building, leading to suboptimal coding efficiency.

In an aspect, reconstructed samples from neighboring coded blocks of a current block is used as reference samples for intra prediction modes including angular and non-angular intra prediction modes to generate prediction samples of the current block.

The reconstructed samples from the spatial neighboring coded blocks may be used as a template (referred to as a current template) of the current block. The template may be used for the template searching to find the prediction block with at least one smallest template-matching cost or be used to derive the intra prediction mode by using the template feature.

A template-based intra prediction method may refer to an intra prediction method that predicts the current block based on the reconstructed samples in the reconstructed neighboring area (e.g., the current template) of the current block. In an aspect, a template-based prediction method refers to a prediction method that predicts the current block based on the reconstructed samples in the reconstructed neighboring area (e.g., the current template) of the current block. A template-based prediction method may refer to a template-based inter prediction method, a template-based intra prediction method, or the like. In some examples, a template-based intra prediction method includes a block vector (BV) based method, such as an intra template matching prediction (IntraTMP) mode. A template-based prediction method may refer to a BV based method, such as the IntraTMP mode, an intra block copy (IBC) mode, or the like.

In some examples, in-loop filters include one or more of (i) a deblocking filter, (ii) a sample adaptive offset (SAO) filter, (iii) an adaptive loop filter (ALF), and/or the like.

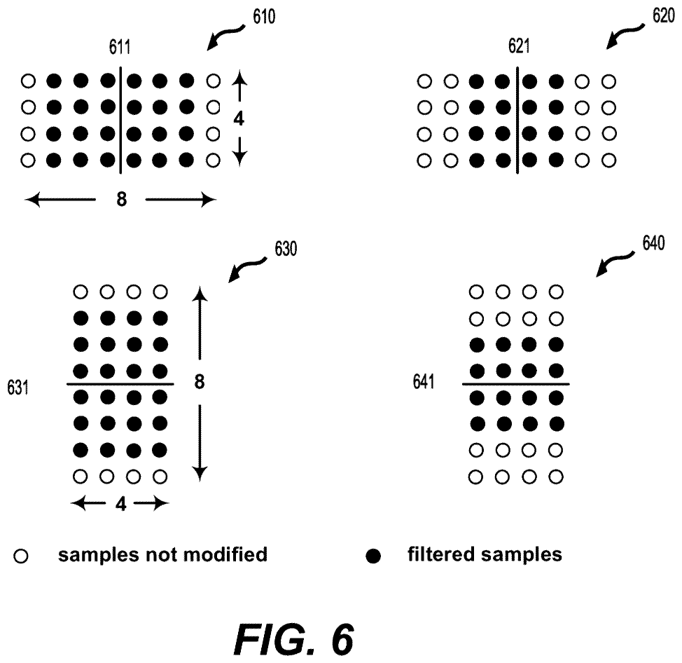

FIG. 6 shows diagrams (610), (620), (630) and (640) for applications of deblocking filters in some examples. For example, in the diagram (610), a deblocking filter is applied to perform a horizontal filtering of a vertical edge (611). Samples on both sides of the vertical edge (611) are involved in the horizontal filtering, and the samples on both sides of the vertical edge (611) can be modified by the horizontal filtering. A filter length may indicate a number of filtered samples along the horizontal axis, such as samples modified by the deblocking filter. The filter length can be changed based on the filtering parameters. For example, in the diagram (620), a similar deblocking filter is applied to perform a horizontal filtering of a vertical edge (621), the number of modified samples along the horizontal axis in the diagram (620) is smaller than the example in the diagram (610). The filter lengths of the deblocking filters shown in (610) and (620) are 3 and 2, respectively. The deblocking filters shown in (610) and (620) are also referred to as horizontal deblocking filters.

In the diagram (630), a deblocking filter is applied to perform a vertical filtering of a horizontal edge (631). Samples on both sides of the horizontal edge (631) are involved in the vertical filtering, the samples on both sides of the horizontal edge (631) can be modified by the vertical filtering. A number of filtered samples (modified samples by the deblocking filter) can be changed based on the filtering parameters. For example, in the diagram (640), a similar deblocking filter is applied to perform a vertical filtering of a horizontal edge (641), the number of modified samples in the diagram (640) is smaller than the example in the diagram (630). The filter lengths of the deblocking filters shown in (630) and (640) are 3 and 2, respectively. The deblocking filters shown in (630) and (640) are also referred to as vertical deblocking filters.

In an example, a sub-stage of deblocking filter refers to a deblocking filter that filters along a single direction, such as the horizontal direction or the vertical direction. Each of the deblocking filters shown in (610), (620), (630), and (640) may be referred to as a sub-stage of deblocking filter.

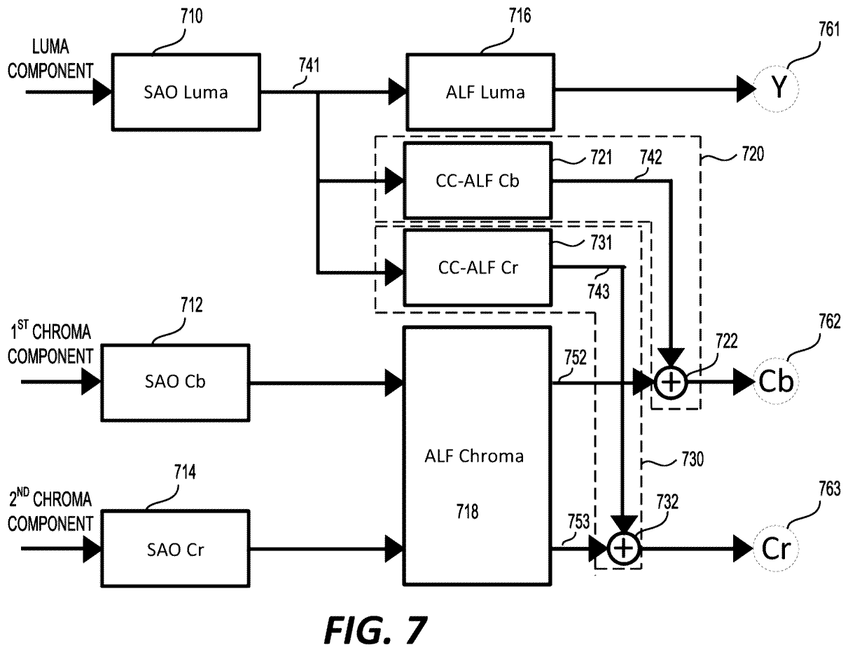

FIG. 7 shows various filters including in-loop filters according to an aspect of the disclosure. FIG. 7 shows in-loop filters for a luma component. FIG. 7 shows in-loop filters for chroma components, such as cross-component filters (e.g., CC-ALFs) used to generate chroma components. In some examples, FIG. 7 shows filtering processes for a first chroma component, a second chroma component, and a luma component. The luma component can be filtered by a SAO filter (710) to generate a SAO filtered luma component (741). The SAO filtered luma component (741) can be further filtered by an ALF luma filter (716) to become a filtered luma CB (761) (e.g., ‘Y’).

The first chroma component can be filtered by a SAO filter (712) and an ALF chroma filter (718) to generate a first intermediate component (752). Further, the SAO filtered luma component (741) can be filtered by a cross-component filter (e.g., CC-ALF) (721) for the first chroma component to generate a second intermediate component (742). Subsequently, a filtered first chroma component (762) (e.g., ‘Cb’) can be generated based on at least one of the second intermediate component (742) and the first intermediate component (752). In an example, the filtered first chroma component (762) (e.g., ‘Cb’) is generated by combining the second intermediate component (742) and the first intermediate component (752) with an adder (722). The cross-component adaptive loop filtering process for the first chroma component can include a step performed by the CC-ALF (721) and a step performed by, for example, the adder (722).

The above description can be adapted to the second chroma component. The second chroma component can be filtered by a SAO filter (714) and the ALF chroma filter (718) to generate a third intermediate component (753). Further, the SAO filtered luma component (741) can be filtered by a cross-component filter (e.g., a CC-ALF) (731) for the second chroma component to generate a fourth intermediate component (743). Subsequently, a filtered second chroma component (763) (e.g., ‘Cr’) can be generated based on at least one of the fourth intermediate component (743) and the third intermediate component (753). In an example, the filtered second chroma component (763) (e.g., ‘Cr’) can be generated by combining the fourth intermediate component (743) and the third intermediate component (753) with an adder (732). In an example, the cross-component adaptive loop filtering process for the second chroma component can include a step performed by the CC-ALF (731) and a step performed by, for example, the adder (732).

A cross-component filter (e.g., the CC-ALF (721), the CC-ALF (731)) can operate by applying a linear filter having any suitable filter shape to the luma component (or a luma channel) to refine each chroma component (e.g., the first chroma component, the second chroma component).

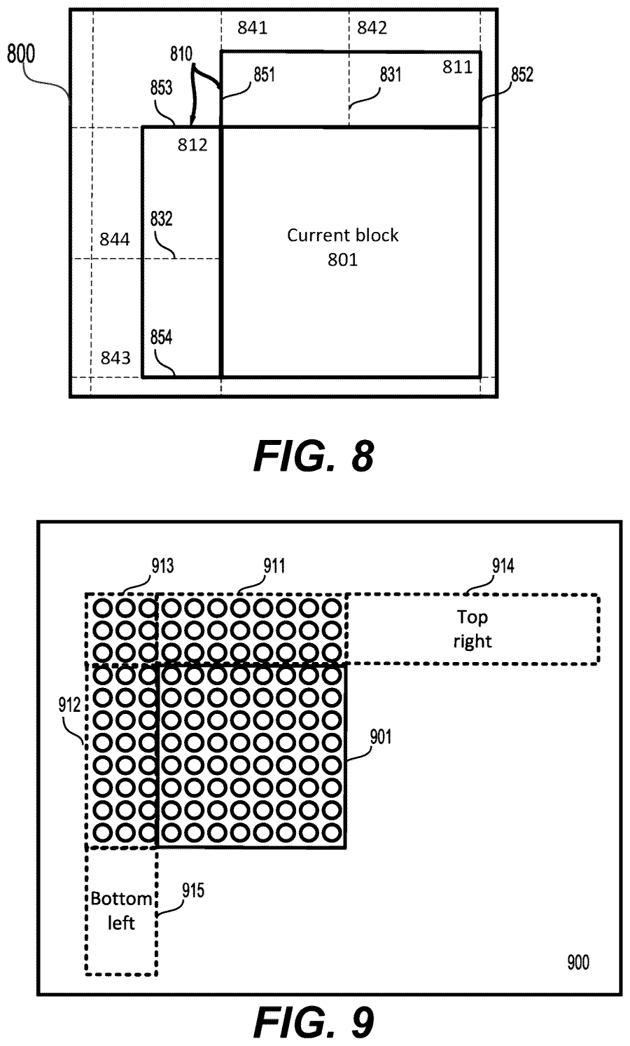

According to an aspect of the disclosure, template filtering for template-based prediction (e.g., template-based inter prediction, template-based intra prediction, or the like) may be used in video coding. In an example, template filtering for inter prediction with its template using one or more in-loop filters is applied. In an aspect, whether to apply a filter to a neighboring reconstructed area of the current block may be determined. FIG. 8 shows an example of a current block (801) in a current picture (800) and a neighboring reconstructed area (810) of the current block (801). In an example, the current block (801) is being coded (e.g., encoded or decoded). The neighboring reconstructed area (810) may be adjacent to the current block (801). The neighboring reconstructed area may (810) include reconstructed samples in the current picture (800). In an aspect, the reconstructed samples in the neighboring reconstructed area (810) have not been filtered, for example, have not been filtered using an in-loop filter. The neighboring reconstructed area (810) may include a current template of the current block. In the example shown in FIG. 8, the current template (810) includes (i) a top template (811) that is directly above the current block (801) and (ii) a left template (812) that is directly to the left of the current block (801). The filter may be applied to the neighboring reconstructed area (810) of the current block (801). The current block (801) may be reconstructed according to the filtered neighboring reconstructed area (810).

In an aspect, the current block (801) is predicted using inter prediction, and the current template (810) used in the inter prediction may be filtered, for example, before the template matching or a model building procedure between the current template (810) and a reference template. In an example, the inter prediction includes one of the template matching and the model building procedure that is based on the current template (810) and reference templates. In an example, the reference templates are in a reference picture that is different from the current picture (800).

In an aspect, the current block is coded using one of (i) intra prediction and (ii) a BV based prediction mode, such as the IntraTMP mode, the IBC mode, or the like.

In an example, the filter includes one or more in-loop filters. The one or more in-loop filters may include one or more of (i) a deblocking filter, (ii) a SAO filter, (iii) a bilateral filter, (iv) an ALF, and/or the like. For example, the applied filter includes at least one or more in-loop filters, such as the deblocking filter, the SAO filter, the bilateral filter, and the ALF.

In an example, the applied filter is but is not limited to the deblocking filter or variations of the deblocking filter.

In an aspect, the applied filter is triggered adaptively according to coding information in the neighboring reconstructed area (810). In an example, whether the filter is applied or not is based on partition information (also referred to as partition information) of the neighboring reconstructed area (or the current template) (810). For example, whether to apply the filter is determined based on the coding information of the neighboring reconstructed area (810). In an example, the coding information of the neighboring reconstructed area (810) includes the partition information of the current template (810).

In an aspect, when edges are detected in the current template (810), the deblocking filter is applied to reduce the blocking artifact. The filter such as the deblocking filter is determined to be applied when an edge is detected in the neighboring reconstructed area (810). In an example, the edge detection region is not limited within the current template (810). The edge detection region may be larger than the current template (810). For example, the current template (810) is an N×1 template including N×1 reconstructed samples where Nis an above template width of the current block (801). The edge detection region (or the N×4 region) may be used for the N×1 template for the edge detection. The N×4 region may include (i) the N×1 template and (ii) an N×3 area that is an extension region of the above template (811) in a vertical direction.

In an aspect, a sub-stage of deblocking filter (e.g., either (i) a horizontal deblocking filter for a vertical edge or (ii) a vertical deblocking filter for a horizontal edge) is applied to the current template (810) adaptively, as shown in FIG. 8. In an example, the top template (811) includes reconstructed samples from neighboring blocks (841)-(842). The neighboring blocks (841)-(842) share a vertical edge (831). In this case, a sub-stage of deblocking filter, e.g., a horizontal deblocking filter for the vertical edge (831) may be applied to the above template (811), and no vertical deblocking filter is applied to the vertical edge (831). In an example, the left template (812) includes reconstructed samples from neighboring blocks (843)-(844). The neighboring blocks (843)-(844) share a horizontal edge (832). In this case, a sub-stage of deblocking filter, e.g., a vertical deblocking filter for the horizontal edge (832) may be applied to the left template (812), and no horizontal deblocking filter is applied to the horizontal edge (832).

In an example, the edge is detected in the neighboring reconstructed area. The deblocking filter is a horizontal deblocking filter when the edge is a vertical edge, for example, when the edge is the vertical edge (831). The deblocking filter is a vertical deblocking filter when the edge is a horizontal edge, for example, when the edge is the horizontal edge (832).

In an example, when the above template (811) includes one or more internal vertical edges, the samples along the one or more vertical edges in the above template (811) may be filtered using the horizontal deblocking filter for the one or more vertical edges. Referring to FIG. 8, the above template (811) includes the vertical edge (831), and the samples along the vertical edge (831) in the above template (811) may be filtered using the horizontal deblocking filter.

In an example, when the left template (812) includes one or more internal horizontal edges, the samples along the one or more horizontal edges in the left template (812) may be filtered using the vertical deblocking filter. Referring to FIG. 8, the left template (812) includes the horizontal edge (832), and the samples along the horizontal edge (832) in the left template (812) may be filtered using the vertical deblocking filter.

As described in FIG. 6, the horizontal deblocking filter may be applied to the vertical edge and the vertical deblocking filter may be applied to the horizontal edge. The left column in FIG. 6 corresponds to a filter length of 3 (e.g., up to 3 samples are filtered on each side of the edge), and up to 3 samples perpendicular to the edges are filtered. The filter length of the right column is 2.

In an example, referring to FIG. 8, samples along two-vertical end-edges (851)-(852) of the above template (811) are filtered. In this case, only samples on one side of the respective edge (851) or (852) are filtered, e.g., only the samples within the above template (811) are filtered. For example, only the samples on the right side of the edge (851) are filtered, and only the samples on the left side of the edge (852) are filtered.

In an example, referring to FIG. 8, samples along two-horizontal end-edges (853)-(854) of the left template (812) are filtered. In this case, only samples on one side of the respective edge (853) or (854) are filtered, e.g., only the samples within the left template (812) are filtered. For example, only the samples on the lower side of the edge (853) are filtered, and only the samples on the upper side of the edge (854) are filtered.

A minimum of a width and a height of the neighboring reconstructed area (810) may be at least 4 samples. In an aspect, the template size is at least four samples. The template size may refer to the height of the above template (811) or the width of the left template (812). For example, the height of the above template (811) and the width of the left template (812) are four samples. In an example, a minimum of a width and a height of the neighboring reconstructed area is at least 4 samples.

In an aspect, the above discussions are applied to any suitable filters, including in-loop filters. The above discussions may be applied similarly to in-loop filters other than the deblocking filter.

In an aspect, the template area is not limited to the direct top and left area, such as the top template (811) and the left template (812) shown in FIG. 8. The template area may include a top-left template, a top-right template, and a bottom-left template, as shown in FIG. 9. In the example of FIG. 9, the template size is 3. FIG. 9 shows examples of a template area or a neighboring reconstructed area of a current block (901) in a current picture (900) according to an aspect of the disclosure. The neighboring reconstructed area of the current block (901) may include one or more of (i) a top template (also referred to as a top neighboring reconstructed area) (911), (ii) a left template (also referred to as a left neighboring reconstructed area) (912), (iii) a top-left template (also referred to as a top-left neighboring reconstructed area) (913), (iv) a top-right template (also referred to as a top-right neighboring reconstructed area) (914), and (v) a bottom-left template (also referred to as a bottom-left neighboring reconstructed area) (915) that are adjacent to the current block (901). In an example, each of (i) the top template (911), (ii) the left template (912), (iii) the top-left template (913), (iv) the top-right template (914), and (v) the bottom-left template (915) includes reconstructed samples in the current picture (900). As shown in FIG. 9, the neighboring reconstructed area of the current block (901) includes one or more of the top neighboring reconstructed area (911) that is directly above the current block (901), the left neighboring reconstructed area (912) that is directly to the left of the current block (901), the top-left neighboring reconstructed area (913), the top-right neighboring reconstructed area (914), and the bottom-left neighboring reconstructed area (915).

In an aspect, the above discussions are applied to a luma component or a chroma component. In an example, the above discussions are applied similarly to the chroma component using a cross-component in-loop filter, such as a cross-component SAO (CCSAO) filter, a CC-ALF, or the like.

In an aspect, a filtering strength and/or a filter condition for a chroma component is derived from information in a luma component that corresponds to the chroma component directly. The filter condition may include whether there is an edge, what kind of filter to apply, and/or the like. The filter strength may include a degree or strength of a filter. An example of the filter strength is a boundary strength (Bs) used to indicate a degree or strength of a deblocking filtering process for an edge. For example, the filtering strength and/or the filter condition for the chroma component is inherited or reused from the filtering strength and/or the filter condition for the luma component, respectively.

In an aspect, an enhancement or an enhancement method of reference pixels (also referred to as reference samples) or a template for intra prediction mode is used. Referring to FIG. 8, the current block (801) in the current picture (800) is not coded (e.g., encoded or decoded) with the inter prediction. For example, the current block (801) is coded with reference samples (e.g., reconstructed samples) in the current picture (800), such as using intra prediction, a block vector (BV) based prediction mode, and/or the like. Examples of the BV based prediction mode include an intra block copy (IBC) mode, an intra template matching prediction (IntraTMP) mode, or the like.

The filter may be applied to the reference samples or the neighboring reconstructed area (or the current template) (810) of the current block (801). The reference samples may include the reconstructed samples in the neighboring reconstructed area (or the current template) (810).

In an aspect, the filter is adaptively applied according to the partition information and/or the coding information within the neighboring reconstructed area (810) (e.g., the reference sample line(s)/column(s)). The neighboring reconstructed area (810) may be referred to as the template area or the current template, and may include the reference sample line(s) and/or reference sample column(s).

In an example, the coding information within the neighboring reconstructed area includes the partition information. The partitioning information may indicate that the neighboring reconstructed area includes reconstructed samples from a plurality of coded blocks in the current picture. The plurality of coded blocks forms at least one coded block boundary in the neighboring reconstructed area. Each of the at least one coded block boundary may be between two adjacent coded blocks in the plurality of coded blocks. The filter is only applied to the reconstructed samples adjacent to the at least one coded block boundary.

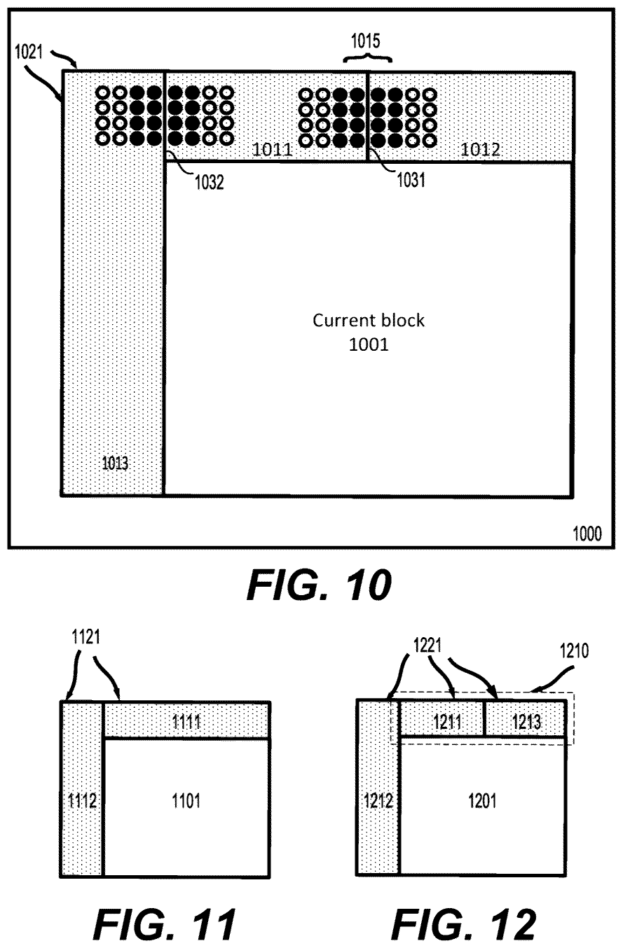

In an aspect, the filter is only applied on the samples along a coded block boundary within the reference sample line/column or the template. The neighboring reconstructed area may be formed by a plurality of coded blocks, and adjacent coded blocks in the plurality of blocks may form a coded block boundary that separate the adjacent coded blocks. FIG. 10 shows an example of a block (or a current block) (1001) and a current template (or a neighboring reconstructed area) (1021) that is formed by three neighboring blocks (1011)-(1013) of the block (1001). In an example, the blocks (1011)-(1013) are already coded, for example, are already reconstructed and include reconstructed samples or reference samples. A coded block boundary (also referred to an edge) (1031) separates the blocks (1011)-(1012). A coded block boundary (1032) separates the blocks (1011) and (1013).

In an example, the filter is applied to the samples along the vertical edges in the top template or reference lines, as shown in FIG. 10. A top template (1015) includes the blocks (1011)-(1012) separated by the vertical edge (1031). The filter is applied to the samples along the vertical edge (1031) in the top template (1015). In an example, the current template (1021) includes the vertical edge (1032). The filter may be applied to the samples along the vertical edge (1032) in the current template (1021). The black dots in FIG. 10 show a filter length (in this case is 2) perpendicular to edges (1031)-(1032). The filter applied to the vertical edge (1031) may be the same as or different from the filter applied to the vertical edge (1032).

In an aspect, the filter is applied row-wise and/or column-wise to every M samples within the neighboring reconstructed area (1021) of the current block (1001) such as the reference sample line(s) and/or reference column(s) or the current template. M may be an integer, such as 1, 2, 4 or 8. In an example, the filter is applied row-wise to the top template (1015), for example, samples in every M columns in the top template (1015) are filtered. The current template (1021) includes the top template (1015) and the left template (1013).

In an aspect, the filter type decision and/or filter strength in the deblocking filter is applicable to the filtering of the reference samples or the current template (1021).

In an aspect, referring back to FIG. 8, the current block (801) is predicted not with the inter prediction, and the current block (801) is predicted using intra prediction or the BV based prediction mode. When an edge is detected in the current template (810), the filter may be applied to samples along the edge. In an example, the edge detection region is not limited within the current template (810), as described above with reference to FIG. 8. The edge detection region may be larger than the current template (810). For example, the current template (1021) may be an N×1 template including N×1 reconstructed samples. The edge detection region (or the N×4 region) may be used for the N×1 template for the edge detection. The N×4 region may include (i) the N×1 template and (ii) an N×3 area that is an extension region of the above template (811) in the vertical direction.

In an aspect, the reference samples or the current template (e.g., (810) in FIG. 8 or (1021) in FIG. 10) is associated with the intra prediction of the current block (e.g., (801) in FIG. 8 or (1001) in FIG. 10).

In an aspect, the filter is applied on a template of a reference block during a template-matching procedure, for example, in the IntraTMP mode when the reference picture refers to a reconstructed region of the current coding frame (also referred to as a current picture). Referring to FIG. 10, the current picture (1000) includes a reconstructed region that is already reconstructed, the current block (1001) that is being reconstructed, and a region to be reconstructed (after the reconstruction of the current block (1001)). The template of the reference block is in the reconstructed region of the current picture (1000) and includes reconstructed samples.

In an aspect, the filter is not only applied to the current template of the current block, but also is applied to the template of the reference block during a template-matching procedure when the reference picture is the reconstructed region of the current coding frame. Referring to FIG. 10, the current picture (1000) includes the reconstructed region that is already reconstructed, the current block (1001) that is being reconstructed, and the region to be reconstructed (after the reconstruction of the current block (1001)). The template of the reference block is in the reconstructed region of the current picture (1000) and includes the reconstructed samples. The filter is applied to the current template (1021) of the current block (1001) and the template of the reference block during the template-matching procedure such as during the IntraTMP.

Signaling based on reference samples features including an efficient method of control information signaling for coding tools that utilize decoder side reference samples information is described according to an aspect of the disclosure, for example, to improve the compression efficiency.

Related video and image codecs utilize decoder available reference samples information as a part of their operating flow. Some examples of such methods include intra prediction (e.g., conventional intra prediction), matrix-based intra prediction (MIP), LIC, and/or the like. In some examples, one of such methods has a control flag indicating that the method is used and some syntax representing a specific template type such as the template is a left template, a top template, an L-shaped template, or the like. Methods of improving efficiency of both the control flag signaling and the template type signaling that are based on the available information such as partitioning and/or prediction information of the neighboring blocks are disclosed.

In an aspect, a template-based prediction method (also referred to as a template-based method or a template-based prediction mode) refers to a prediction method that predicts a current block (also referred to as a current coding block) in a current picture based on reconstructed samples in the current picture. The reconstructed samples in the current picture may be referred to as decoder available reconstructed samples or decoder available reference samples. In an aspect, the reconstructed samples in the current picture used in the template-based prediction method are in a reconstructed neighboring area (e.g., a current template) of the current block. In this disclosure, without loss of generality any intra or inter coding methods that may utilize information of the decoder available reconstructed samples of the current coding block may be called “template-based methods” and the decoder available reference samples area may be called “a template” (e.g., the current template) or “a template area”. For example, the reconstructed neighboring area or the current template of the current block is used in mode derivation for the current block, predicting the current block, and/or the like.

Examples of the template-based prediction methods include the MIP, the LIC, intra prediction modes (e.g., angular intra prediction modes), the IntraTMP, template matching based inter prediction, and/or the like.

In an aspect, signaling of a control flag, a template type, a template-based method type of a template-based method is performed based on at least one of the partitioning information and prediction information corresponding to the template area.

According to an aspect of the disclosure, whether one of (i) the control flag of the prediction mode (e.g., the template-based prediction mode) used to predict the current block in the current picture and (ii) a type of the prediction mode (e.g., the type of the template-based method) is to be signaled in a video bitstream may be determined based on one of the partitioning information and the prediction information of the reconstructed samples in the current picture (or the decoder available reconstructed samples). In an example, whether the one of (i) the control flag of the prediction mode used to predict the current block in the current picture and (ii) the type of the prediction mode is to be signaled in the video bitstream is determined based on the one of the partitioning information and the prediction information of the neighboring reconstructed area of the current block. The current block may be predicted based on reconstructed samples in the neighboring reconstructed area that is adjacent to the current block. The current block may be encoded according to the prediction mode and the reconstructed samples in the neighboring reconstructed area. When the one of the control flag and the type of the prediction mode is determined to be signaled, the one of the control flag and the type of the prediction mode is encoded in the video bitstream.

In an aspect, signaling of the control flag of the template-based method may be performed based on the partitioning information corresponding to the template area. In an example, the partitioning information corresponding to the template area refers to the partitioning information of the template area.

In an aspect, the control flag is signaled only if the template (the current template) satisfies specific conditions that are determined based on the neighboring blocks partition information, which is the partition information of neighboring blocks in the neighboring reconstructed area (e.g., the current template). For example, whether the control flag of the prediction mode is to be signaled in the video bitstream is determined based on the partitioning information of the neighboring reconstructed area of the current block.

In an example, the control flag is signaled only if the template area belongs to no more than L different coding blocks. Otherwise, the control flag is not signaled, and a value of the control flag is inferred as zero (e.g., disabled). For example, that the control flag of the prediction mode is to be signaled in the video bitstream is determined only when the partitioning information indicates that the reconstructed samples in the neighboring reconstructed area are from no more than L difference coding blocks.

FIG. 11 shows an example of a block (e.g., a current block) (1101) and a template (e.g., a current template) (1121) according to an aspect of the disclosure. The current template (1121) is formed by two neighboring blocks (1111)-(1112). In the example shown in FIG. 11, the current block (1101) is a square block, and the current template (1121) is an L-shape template area formed by the two neighboring blocks (1111)-(1112). In this example having value L set to 2, the control flag of the template-based method is signaled.

FIG. 12 shows an example of a block (e.g., a current block) (1201) and a template (e.g., a current template) (1221) according to an aspect of the disclosure. The current template (1221) is formed by three neighboring blocks (1211)-(1213). In the example shown in FIG. 12, the current block (1201) is a square block, and the current template (1221) is an L-shape template area formed by the three neighboring blocks (1211)-(1213). In this example having value L set to 2, the control flag of the template-based method is not signaled and may be inferred as 0.

In an example, if an actual template area (e.g., the current template) to-be-used by the template-based method cannot be determined prior to the control flag signaling and/or reading, (i) a subset of all possible template areas or (ii) the maximal possible template area may be used to determine whether the control flag is to be signaled and/or read. In an example, the maximal possible template area includes all the possible template areas.

In an example, when the control flag is determined to be signaled, an entropy context of the control flag is determined based on the partitioning information of in the neighboring reconstructed area (e.g., the current template).

In an aspect, the entropy context of the control flag is determined based on the neighboring blocks partition information which is the partition information of the neighboring blocks in the neighboring reconstructed area (e.g., the current template). In an example, if the template area belongs to no more than N different coding blocks, one context (e.g., a first context) is selected; otherwise, if the template area belongs to no more than M blocks, another context (e.g., a second context) is selected where M>N. In an example, if the template area belongs to more than M blocks, a third context is selected.

In an example, if the template area is formed by two neighboring blocks, the context for the control flag is set to 0 indicating the context is the first context; otherwise, if the template area is formed by three neighboring blocks, the context for the control flag is set to 1 indicating that the context is the second context; otherwise, the context for the control flag is set to 2 indicating that the context is the third context, and the like.

In another example, if the template area is formed by two neighboring blocks, the context for the control flag is set to 0 indicating the context is the first context; otherwise, the context for the control flag is set to 1 indicating that the context is the second context.

In another example, if the template area is formed by the minimal possible number of the neighboring blocks, the context for the control flag is set to 0 indicating the context is the first context; otherwise, the context for the control flag is set to 1 indicating that the context is the second context. For example, if the minimal possible number is 2, and the template area includes two neighboring blocks, then the context for the control flag is the first context; otherwise, the context for the control flag is the second context.

In another example, if the template area is formed by two neighboring blocks, the previously determined context number for the control flag is multiplied to 1; otherwise, if the template area is formed by three neighboring blocks, the context for the control flag is multiplied to 2; otherwise, the context for the control flag is multiplied to 3, and the like. In an example, the previously determined context number for the control flag is based on a decoding order or an encoding order. In an example, the decoding order is the same as the encoding order.

In another example, if the template area is formed by two neighboring blocks, the previously determined context number for the control flag is multiplied to 1; otherwise, it is multiplied to 2.

Methods of context selection in the disclosure may be combined with any other context selection methods such as analyzing similarity of the control flags of the neighboring (e.g. left and top) blocks.

In an aspect, signaling of the template type of the template-based method may be performed based on the partitioning information corresponding to the template area. In an example, that the neighboring reconstructed area (or the current template) to be used to predict the current block is determined and the neighboring reconstructed area (or the current template) is signaled based on the partitioning information of the neighboring reconstructed area.

In an aspect, a specific template type can be signaled only if the template satisfies specific conditions that are determined based on the partition information of the template area, such as the partition information of the neighboring blocks in the template area.

In an example, if the template area is formed by more than N blocks, the template cannot be signaled and cannot be used. For example, the reconstructed samples in the template area (e.g., the neighboring reconstructed area) are constrained to no more than N difference coding blocks. FIG. 12 shows an example of the current square block (1201) and the current template (1221). The current template (1221) may include a top template and a left template which is the block (1212). The top template is formed by the two coding blocks (1211) and (1213). If N is set to 1, the top template cannot be signaled and cannot be used, for example, because the top template is formed by more than N (e.g., 1) block.

In an aspect, specific template type signaling (such as a binarization scheme) may be determined based on the partition information of the template area (or the current template).

In an aspect, template candidates (e.g., all possible templates) may form an ordered list (also referred to as a template list) based on the partitioning information that corresponds to each of the template candidate (e.g., the respective one of the possible templates) and signaling may be performed differently based on the different positions of the template candidates in the template list. The template candidates may refer to a plurality of neighboring reconstructed areas that is adjacent to the current block.

In an example, a list (e.g., the template list) including the plurality of neighboring reconstructed areas (e.g., the plurality of template candidates) that is adjacent to the current block is constructed based on respective partitioning information of the plurality of neighboring reconstructed areas. The plurality of neighboring reconstructed areas includes the neighboring reconstructed area. The neighboring reconstructed area may be signaled based on a position of the neighboring reconstructed area in the list.

In an example, if the template-based prediction method allows signaling of a left template, a top template, or an L-shape template, the template list is firstly constructed by checking a number of partitions that belong to each of the templates (e.g., the left template, the top template, or the L-shape template) and the template list may be ascendingly ordered such that the first position is the template list is set to the template with less partitions (e.g., with the least partitions) and a lower number in the template list corresponds to a shorter codeword in the bitstream.

In the example shown in FIG. 12, the template candidates include the left template (1212), the top template (1210) that includes the blocks (1211) and (1213), and the L-shaped template (1221). The ordered list (i.e., the template list) of possible partitioning can be formed as 1: “the left template (1212)”, 2: “the top template (1210)”, and 3: “the L-shape template (1221)” as the left template (1212) is formed by only one block (e.g., no template partitioning involved in the left template (1212)), the top template (1210) is formed by two blocks, and the L-shape template (1221) is formed by the three blocks (1211)-(1213). In an example, the binarized signaling is implemented as following: “0” indicates the left template (1212), “01” indicates the top template (1210), and “11” indicates the L-shape template (1221). In this example, one bit “0” is used to signal the left template (1212), two bits “01” is used to signal the top template (1210), and two bits “11” is used to signal the L-shape template (1221).

In another aspect, an entropy context of the template type is determined based on the partition information of the current template.

In an aspect, signaling of the template-based method type is performed based on the partitioning information and/or the prediction information corresponding to the template area. The template-based method type may refer to the type of the template-based method. A plurality of template-based methods may have the same template-based method type. An example of the template-based method type is intra prediction, and an example of the template-based method is a specific angular intra prediction mode.

In an aspect, only the partition information of the reference data (e.g., the reconstructed samples) from the template area is used for signaling and/or entropy context modeling and the reference data may be used to generate the prediction samples of the current block. For example, only the partition information within the above template area is used for signaling and/or entropy context modeling when the prediction samples of the current block is predicted from the above template only.

A picture can be partitioned into a plurality of CUs using any suitable method. For example, according to the HEVC standard, a picture can be split into a plurality of CTUs. Further, a CTU can be split into CUs by using a quad-tree (QT) structure denoted as a coding tree to adapt to various local characteristics of the picture. The decision whether to code a picture area using an inter-picture prediction (also referred to as a temporal prediction or an inter prediction type), an intra-picture prediction (also referred to as a spatial prediction, or an intra-prediction type), and the like is made at the CU level. Each CU can be further split into one, two or four PUs according to a PU splitting type. Inside one PU, the same prediction process is applied and the same prediction information is transmitted to a decoder on a PU basis. After obtaining residual data or residual information by applying the prediction process based on the PU splitting type, the CU can be partitioned into TUs according to another quadtree structure similar to the coding tree for the CU. In an example, a transform is applied for each TU having the same transform information. The HEVC structure has multiple partition units including a CU, a PU, and a TU. Samples in a CU can have the same prediction type, samples in a PU can have the same prediction information, and samples in a TU can have same transform information. A CU or a TU has a square shape, while a PU can have a rectangular shape, which includes a square shape in some embodiment, for an inter-predicted block. In some examples, such as in the JEM standard, PUs having rectangular shapes can be used for an intra prediction.

According to the HEVC standard, an implicit QT split is applied to a CTU located at a picture boundary to recursively split the CTU into a plurality of CUs so that each CU is located inside the picture boundary.

In various embodiments, such as in the HEVC standard, a CTB, CB, PB, and a transform block (TB) can be used to specify, for example, 2D sample arrays of one color component associated with a respective CTU, CU, PU, and TU, respectively. Therefore, a CTU can include one or more CTBs, such as one luma CTB and two chroma CTBs. Similarly, a CU can include one or more CBs, such as one luma CB and two chroma CBs.

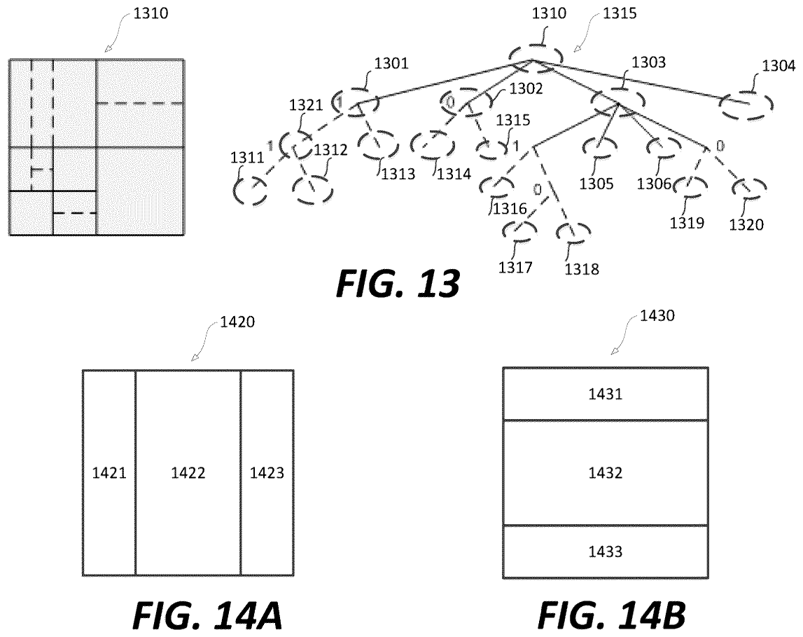

In addition to the block partitioning described above, FIG. 13 shows an example of a block partitioning structure according to an aspect of the disclosure. The block partitioning structure uses a QT plus binary tree (BT), and can be referred to as a QTBT structure or a QTBT partitioning. Compared to the QT structure described above, the QTBT structure removes a separation of the CU, PU, and TU, and supports more flexibility for CU partition shapes. In the QTBT structure, a CTU is split using the QTBT structure into a plurality of CUs, and a CU can have a rectangular shape, which includes a square shape in some embodiments. In various embodiments, the CUs serve as units for prediction and transform, thus, samples in a CU can have the same prediction type, can be coded using the same prediction process, can have the same prediction information, and the same transform information.

FIG. 13 (left) illustrates an example of a block partitioning using a QTBT partitioning, and FIG. 13 (right) illustrates a corresponding QTBT tree representation (1315). The solid lines indicate QT splits and dotted lines indicate BT splits. In each split (i.e., non-leaf) node of the binary tree, a flag is signaled to indicate a split type (i.e., a symmetric horizontal split or a symmetric vertical split) used. For example, “0” indicates the symmetric horizontal split and “1” indicates the symmetric vertical split. For a quadtree split, a split type is not indicated or signaled because the quadtree split splits a non-leaf node both horizontally and vertically to produce 4 smaller nodes with an equal size.

Referring to FIG. 13, a CTU (1310) is first partitioned (or split) by a quadtree structure into nodes (1301)-(1304). The nodes (1301)-(1302) are further partitioned by a binary tree structure, respectively. As described above, a BT split includes two split types, i.e., the symmetric horizontal split and the symmetric vertical split. The quadtree node (1303) is further partitioned by a combination of a BT structure and a QT structure. The node (1304) is not further partitioned. Accordingly, binary tree leaf nodes (1311)-(1320) and quadtree leaf nodes (1304)-(1306) that are not split further are CUs used for prediction and transform processing. In this example, a CU, a PU, and a TU are identical in the QTBT structure. For example, samples in a CU have the same prediction type, the same prediction information, and the same transform information. In the QTBT partitioning, a CU can include CBs of different color components, e.g., one CU includes one luma CB and two chroma CBs in the case of P and B slices of the 4:2:0 chroma format. In some examples, a CU can include a CB of a single component, e.g., one CU includes one luma CB or two chroma CBs in the case of I slices.

The following parameters are defined for a QTBT partitioning. A CTU size refers to a root node size of a quadtree. For example, the root node or the CTU in the FIG. 13 example is (1310). A MinQTSize refers to a minimum allowed quadtree leaf node size. A MaxBTSize refers to a maximum allowed binary tree root node size. For example, the node (1301) is a binary tree root node in the FIG. 13 example. A MaxBTDepth refers to a maximum allowed binary tree depth. A MinBTSize refers to a minimum allowed binary tree leaf node size.

In one example of the QTBT partitioning, the CTU size is set as 128×128 luma samples with two corresponding 64×64 blocks of chroma samples, the MinQTSize is set as 16×16, the MaxBTSize is set as 64×64, the MinBTSize (for both width and height of a binary tree leaf node) is set as 4×4, and the MaxBTDepth is set as 4. The quadtree partitioning is applied to the CTU first to generate quadtree leaf nodes. The quadtree leaf nodes may have a size from 16×16 (i.e., the MinQTSize) to 128×128 (i.e., the CTU size). If the quadtree leaf node is 128×128, the quadtree leaf node is not further split by the binary tree since the size 128×128 exceeds the MaxBTSize (i.e., 64×64). Otherwise, the quadtree leaf node can be further partitioned by the binary tree. Therefore, the quadtree leaf node can be the root node for the binary tree and has the binary tree depth as 0. When the binary tree depth reaches the MaxBTDepth (i.e., 4), no further split is implemented. When the binary tree node has a width equal to the MinBTSize (i.e., 4), no further horizontal split is implemented. Similarly, when the binary tree node has a height equal to the MinBTSize, no further vertical split is implemented. The leaf nodes of the binary tree are further processed or coded by prediction and transform processing without any further partitioning. In the JEM standard, in some examples, the maximum CTU size is 256×256 luma samples.

In some examples, such as for P and B slices, the luma and chroma CTBs in one CTU share the same QTBT structure. On the other hand, the QTBT partitioning supports an ability for the luma and chroma to have a separate QTBT structure. For example, such as for I slices, the luma CTB is partitioned into luma CUs by a QTBT structure, and the chroma CTBs are partitioned into chroma CUs by another QTBT structure. Therefore, a CU in an I slice can include a CB of the luma component or CBs of two chroma components, and a CU in a P or B slice can include CBs of all three color components.

In some examples, such as in the HEVC standard, an inter prediction for small blocks is restricted to reduce memory access of motion compensation, such that bi-prediction is not supported for 4×8 and 8×4 blocks, and an inter prediction is not supported for 4×4 blocks. In some embodiments, such as in the QTBT implemented in the JEM standard, the above restrictions are removed.

A multi-type-tree (MTT) structure can be a flexible tree structure. In the MTT, a horizontal and vertical center-side triple-tree (TTs) partitioning or split can be used, as shown in FIGS. 14A-14B. The triple-tree partitioning can also be referred to as tertiary tree partitioning. FIG. 14A shows an example of a vertical center-side triple-tree partitioning. For example, an area (1420) is vertically split into three sub-areas (1421)-(1423) where the sub-area (1422) is located in the middle of the area (1420). FIG. 14B shows an example of a horizontal center-side triple-tree partitioning. For example, an area (1430) is horizontally split into three smaller sub-areas (1431)-(1433) where the sub-area (1432) is located in the middle of the area (1430). In various examples, the areas (1420) and (1430) can be CTUs or CUs, nodes that can be further split such as the node (1301). One or more of the sub-areas (1421)-(1423) and (1431)-(1433) can be CUs that are not partitioned further or nodes that can be subsequently partitioned.

According to an aspect of the disclosure, a set of methods for video compression including partitioning is described. The partitioning methods include a flexible partition split approach in video coding.

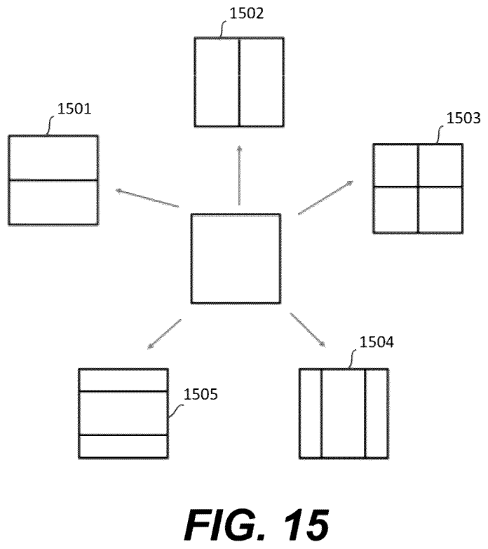

When compressing a video frame, a block-based video codec may partition the pixels or samples in the video frame into multiple rectangular areas known as blocks, and different compression strategies may be applied to each block. The pixel area may be partitioned into blocks recursively. At each partition depth, a flag may be signaled to indicate whether the current area is to be further split or not. A block is formed at the current area if no further split is to occur. If further splits are to occur, a split type may be signaled to indicate the way to subdivide the current area into multiple sub-areas. This process may continue recursively. In some video coding standards, each of the possible partition split types is typically fixed. For example, the H.266 video coding standard provides 5 partition split types to divide an area into smaller sub-areas. In various examples, each of the 5 split types divides the current area into sub-areas in a fixed way. FIG. 15 shows an example of possible partition splits (e.g., five fixed partition splits) according to an aspect of the disclosure. The partition splits (1501)-(1505) shown in FIG. 15 may be used in the H.266 video coding standard. The partition split (1501) refers to a BT such as the symmetric horizontal split. The partition split (1502) refers to a BT such as the symmetric vertical split. The partition split (1503) refers to a QT. The partition split (1504) refers to a TT such as the horizontal center-side triple-tree partitioning. The partition split (1505) refers to a TT such as the vertical center-side triple-tree partitioning.

In an aspect a split type referred to as a flexible partition split is described. Similar to the fixed partition splits such as those described with references to FIGS. 13-15, the flexible partition split type may be chosen at each partition depth. Unlike the fixed partition splits that divide the current area into sub-areas in specific ways, the split regime (also referred to as the partition regime or a partition structure) of flexible partition split is derived based on neighborhood information or signaled information. The split regime refers to the way that the sub-areas are generated or how the current area is partitioned. When the flexible partition split is used, the partition regime may vary.

According to an aspect of the disclosure, coded information of the current area to be partitioned in a current picture may be received. The partition regime or the partition structure of the current area may be determined based on one of (i) size information of the current area and (ii) partitioning information of another area. The current area may be reconstructed based on the determined partition structure of the current area.

In an aspect, the flexible partition reuses the same partition regime used in another area of the same size. In an example, in intra frames, the other area is in the same picture (e.g., the current picture) as the current area. In inter frames, the other area may be in (i) a picture that is different from the current picture or (ii) the current picture.

In an aspect, the flexible partition reuses the partition regime in a same-size area located in an arbitrary location of the coded frame for the current area. In an aspect, partitioning is determined in the parsing stage, and the other area is already parsed. For example, the partition regime in the other area is reused as the partition regime of the current area where the other area has the same size as the current area and is located in the arbitrary location of the coded frame. In some examples, the coded frame may refer to the current frame that is being coded, and the partitioning information available in the coded frame is of an area that is already parsed. Thus, if the other area is in the current picture (or the current frame), the other area is already parsed. In some examples, the other area may be in a picture (different from the current picture) that is already parsed.

In one example, the flexible partition reuses the partition regime in the same-size area located to the left of the current area.

In one example, the flexible partition reuses the partition regime in the same-size area located above the current area (e.g., at the top of the current area).

In one example, the flexible partition reuses the partition regime in the same-size area located to the top-left of the current area.

In one example, the flexible partition reuses the partition regime in a same-size area signaled by a displacement vector with respect to the current area in the bitstream.

In one example, the flexible partition reuses the partition regime in a same-size area derived based on neighborhood partition information of the current area. The neighborhood partition information of the current area may indicate partition information of the neighboring area of the current area. In an example, the neighboring area has already been parsed.

In an aspect, the flexible partition predicts the partition region (e.g., the partition structure) for the current area based on size information of the current area, neighbor information, and/or the signaled information.

In an aspect, the flexible partition is predicted based on the size information of the current area and/or the neighborhood partition information (e.g., the partition information of the neighboring area of the current area). In an example, the neighboring area has already been parsed.

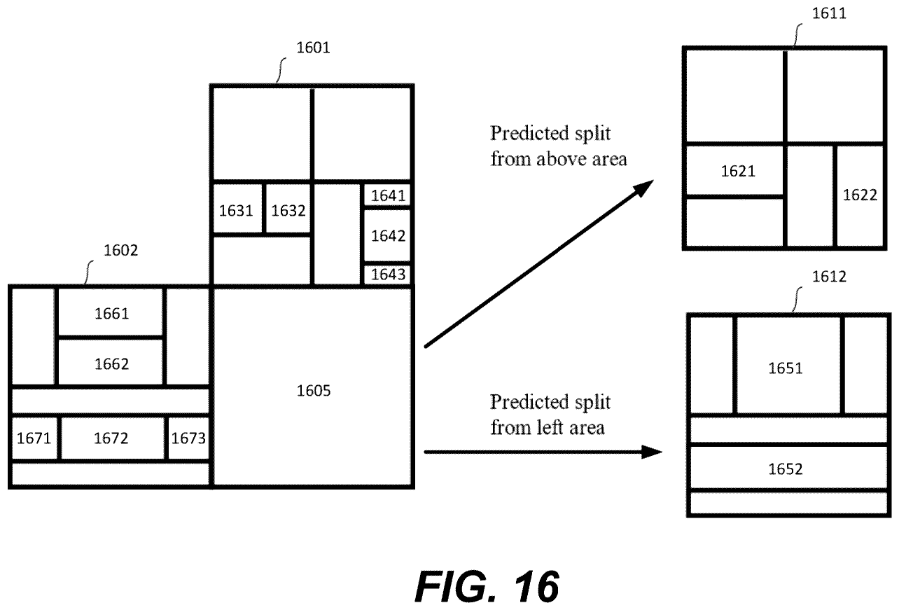

In an example as shown in FIG. 16, the flexible partition is predicted using the partition information from the same-size area that is above or to the left of the current area by reducing the depth of partition splits by a constant factor (e.g., 1). FIG. 16 shows an example of the flexible partition split predicted from the above area (1601) or from the left area (1602) of the current area (1605) with the partition depth reduced by 1. The above area (1601) and the left area (1602) have the same size as the size of the current area (1605). The partition depths of the above area (1601) and the left area (1602) are 3.

A partition pattern (1611) has a partition depth of 2 which is the partition depth of the above area (1601) reduced by 1. For example, the above area (1601) is firstly partitioned into the partition pattern (1611), and then a block (1621) is further partitioned into blocks (1631)-(1632) using the BT and a block (1622) is further partitioned into blocks (1641)-(1643) using the TT. When the current area (1605) is partitioned using the partition information of the above area (1601), the current area (1605) is partitioned using the partition pattern (1611).

A partition pattern (1612) has a partition depth of 2 which is the partition depth of the left area (1602) reduced by 1. For example, the left area (1602) is firstly partitioned into the partition pattern (1612), and then a block (1651) is further partitioned into blocks (1661)-(1662) using the BT and a block (1652) is further partitioned into blocks (1671)-(1673) using the TT. When the current area (1605) is partitioned using the partition information of the left area (1602), the current area (1605) is partitioned using the partition pattern (1612).

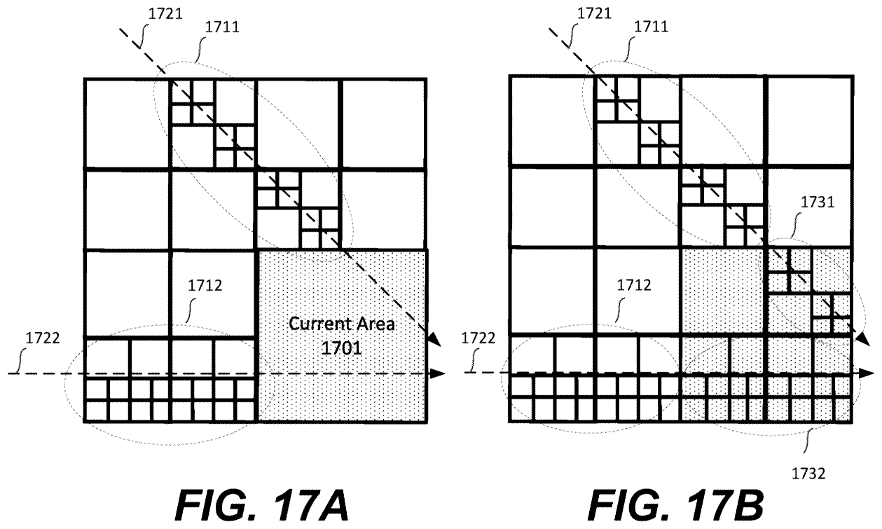

In an example, the flexible partition is predicted using the directionality of the partition information in the neighborhood of the current area. FIGS. 17A-17B show the flexible partition split predicted using the directionality of partition information in the neighborhood (or a neighboring area) of a current area (1701). The predicted flexible partition split is shown in FIG. 17B.

In an aspect, the neighboring area of the current area (1701) is analyzed to determine the occurrence partitions (e.g., small partitions with partition depths that satisfy a condition, such as larger than or equal to a threshold) that may be grouped by underlying directions of the partitions, and then the direction information may be used to predict partition in the current area (1701). In an example, the direction information may be extrapolated into the current area (1701), and generating the prediction of the flexible partition split in the current area (1701). Referring to FIGS. 17A-17B, the neighboring area of the current area (1701) includes a first group of partitions (1711) and a second group of partitions (1712). The first group of partitions (1711) are located along a first direction (1721). Partitions (1731) in the current area (1701) may be generated by extrapolating the first group of partitions (1711) along the first direction (1721) into the current area (1701). The second group of partitions (1712) are located along a second direction (1722). Partitions (1732) in the current area (1701) may be generated by extrapolating the second group of partitions (1712) along the second direction (1722) into the current area (1701).

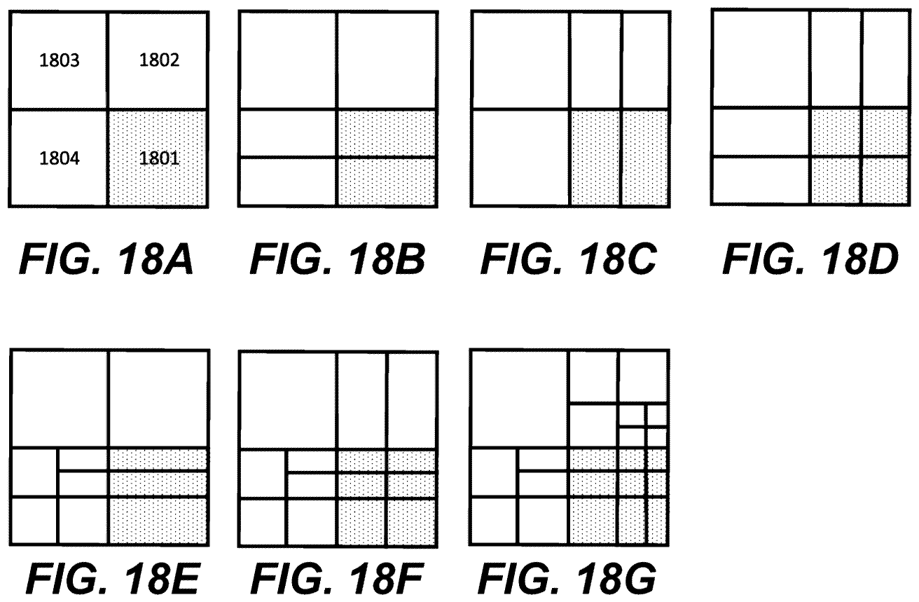

In an example, the flexible partition is predicted by extrapolating the partition information in the neighborhood area of the current area. FIGS. 18A-18G show flexible partitions predicted by extrapolating partition information in a neighborhood area (also referred to as a neighboring area) of a current area (1801). FIG. 18A shows the current area (1801) and neighboring areas (1802)-(1804).

In FIG. 18B, the partition pattern of the current area (1801) is predicted from the partition pattern of the neighboring area (1804), for example, the partition pattern of the neighboring area (1804) is used directly as the prediction of the partition pattern of the current area (1801).

In FIG. 18C, the partition pattern of the current area (1801) is predicted from the partition pattern of the neighboring area (1802), for example, the partition pattern of the neighboring area (1802) is used directly as the prediction of the partition pattern of the current area (1801).

In FIG. 18D, the partition pattern of the current area (1801) is predicted from the partition patterns of the neighboring areas such as (1802) and (1804).

In FIG. 18E, the partition pattern of the current area (1801) is predicted from the partition pattern of the neighboring area (1804), and the partition pattern of the current area (1801) is different from the partition pattern of the neighboring area (1804).

In FIGS. 18F-18G, the partition pattern of the current area (1801) is predicted from the partition patterns of the neighboring areas such as (1802) and (1804).

In an example, the flexible partition is predicted using learning-based methods with the size information of the current area and/or neighborhood partition information of the current area as input(s). The neighborhood partition information of the current area indicates partition information of the neighboring area of the current area.

In an example, multiple flexible partition possibilities are predicted using learning-based methods with the size information of the current area and/or the neighborhood partition information of the current area as the input(s). An additional flag may be signaled to determine which flexible partition possibility is used.

In an aspect, the flexible partition may be predicted based on the partition information in another area (also referred to as a reference area). In an example, the other area (or the reference area) is already parsed and the partition information is available.

In an example, the reference area is signaled with a displacement vector with respect to the current area.

In an example, the displacement vector is derived based on the pixel similarity of the template (e.g., a reference template) of the reference area and the template (e.g., the current template) of the current area.

In an example, a number of coded/prediction blocks are signaled to indicate how many associated coded/prediction blocks are to be parsed during the bitstream parsing stage when the flexible partition cannot be further split.

In an example, an end of consecutive coded/prediction blocks flag is signaled to indicate whether the end of the flexible partition is reached or not.

In an example, the number of CUs in the flexible partition is signaled.

In an example, the width and/or the height of CUs in the flexible partition is signaled.

In an example, a magnitude of the horizontal component and the vertical component of the displacement vector (the displacement vector may be derived or signaled) is a power of 2.

In an example, the magnitude of the horizontal component and the vertical component of the displacement vector is N-times of the width and the height of the magnitude of the horizontal component and the vertical component of the displacement vector, respectively, where N is a non-zero positive integer value.

In an example, the pixel similarity between the reference area and its neighboring top, left, and top-left areas are calculated. The partition decision of the block with the highest pixel similarity is reused for the current area.

In an aspect, after the flexible partition split is derived, the derived flexible split may be further modified (e.g., corrected) using a prior split regime.

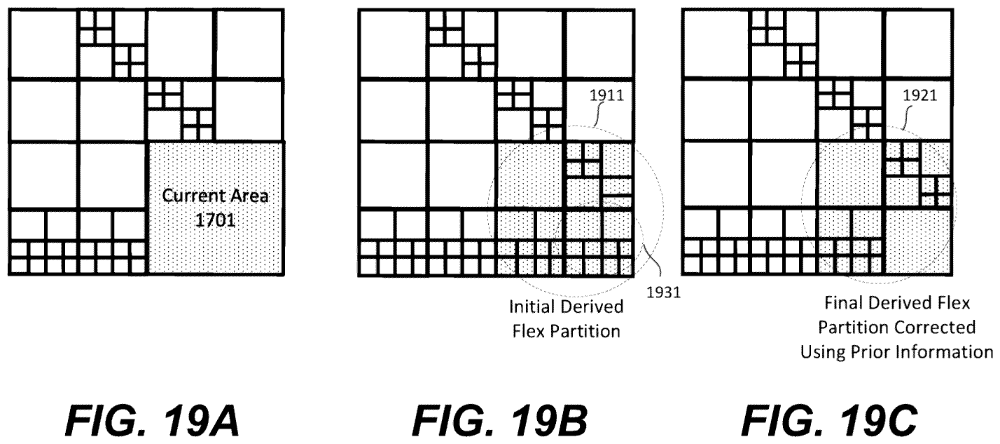

FIGS. 19A-19C show an example of correcting a derived flexible partition split using prior information. The descriptions for FIGS. 19A-19B are the same as the descriptions for FIGS. 17A-17B. The partition pattern of the current area (1701) in FIG. 19A is predicted using the directionality of the partition information of the neighboring area of the current area (1701), such as described in FIGS. 17A-17B. The split regime in the bottom-right area in FIG. 19B shows the initial derived flexible partition (1911) that is derived from the neighboring area of the current area (1701).

FIGS. 19B-19C show that the initial derived flexible partition (1911) is modified to generate a final derived flex partition (1921). As shown in FIG. 19B, the initial derived flexible partition (1911) of the current area (1701) includes a partition pattern (1931) of the bottom-right area in the current area (1701), and the partition pattern (1931) is replaced with no split as shown in FIG. 19C. Thus, the final derived flex partition (1921) is the initial derived flexible partition (1911) corrected using prior information, which allows more flexibility.

In an aspect, when the flexible partition split is derived for the current partition, multiple scanning and/or coding orders may be allowed, and the actual order may be determined by a signaled syntax or implicitly (e.g., without signaling) determined by neighboring block information.

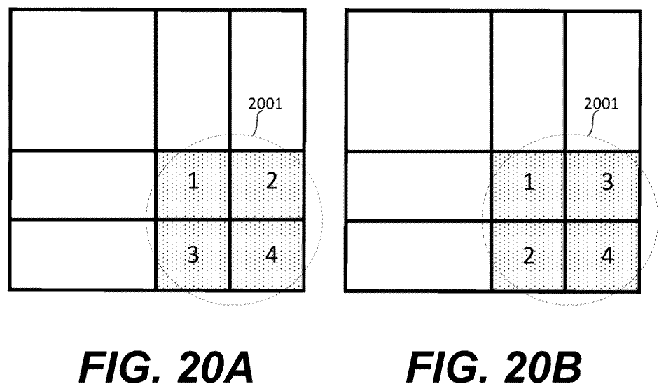

FIGS. 20A-20B show examples of the flexible partition with multiple scanning orders for a current block (2001) according to an aspect of the disclosure. FIG. 20A shows a first scanning order for the current block (2001), and the first scanning order is the top-left region, the top-right region, the bottom-left region, and the bottom-right region where the top-left region is the first to be scanned and the bottom-right region is the last to be scanned. FIG. 20B shows a second scanning order for the current block (2001), and the second scanning order is the top-left region, the bottom-left region, the top-right region, and the bottom-right region where the top-left region is the first to be scanned and the bottom-right region is the last to be scanned.

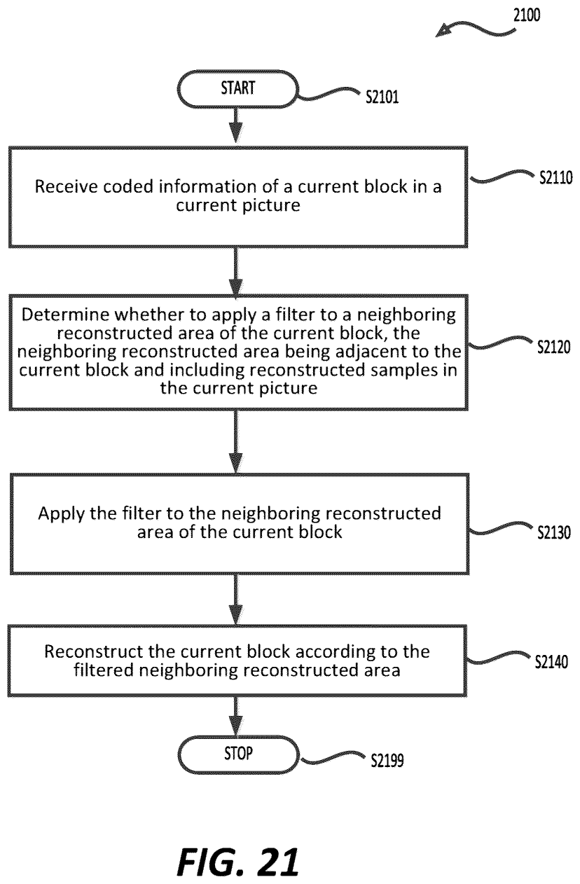

FIG. 21 shows a flow chart outlining a process (2100) according to an aspect of the disclosure. The process (2100) may be used in an apparatus, such as a video decoder. In various aspects, the process (2100) is executed by processing circuitry, such as the processing circuitry that performs functions of the video decoder (110), the processing circuitry that performs functions of the video decoder (210), and the like. In some aspects, the process (2100) is implemented in software instructions, thus when the processing circuitry executes the software instructions, the processing circuitry performs the process (2100). The process starts at (S2101) and proceeds to (S2110).

At (S2110), coded information of a current block in a current picture may be received.

In an example, the current block is coded using inter prediction, and the neighboring reconstructed area is a current template of the current block.

In an example, the current block is coded using one of (i) intra prediction and (ii) a block vector (BV) based prediction mode.

At (S2120), whether to apply a filter to a neighboring reconstructed area of the current block is determined. The neighboring reconstructed area is adjacent to the current block and includes reconstructed samples in the current picture.

In an example, the filter includes one or more in-loop filters.

In an example, the one or more in-loop filters include one or more of (i) a deblocking filter, (ii) a sample adaptive offset (SAO), (iii) a bilateral filter, and (iv) an adaptive loop filter (ALF).

In an example, a deblocking filter is determined to be applied when an edge is detected in the neighboring reconstructed area. The filter includes the deblocking filter.

In an example, the edge is detected in the neighboring reconstructed area, the deblocking filter is a horizontal deblocking filter when the edge is a vertical edge, and the deblocking filter is a vertical deblocking filter when the edge is a horizontal edge.

In an example, whether to apply the filter is determined based on coding information of the neighboring reconstructed area.

In an example, the coding information includes partitioning information. The partitioning information indicates that the neighboring reconstructed area includes reconstructed samples from a plurality of coded blocks in the current picture, the plurality of coded blocks forms at least one coded block boundary in the neighboring reconstructed area, and each of the at least one coded block boundary is between two adjacent coded blocks in the plurality of coded blocks. That the filter is only applied to the reconstructed samples adjacent to the at least one coded block boundary is determined.

In an example, a minimum of a width and a height of the neighboring reconstructed area is at least 4 samples.

In an example, the neighboring reconstructed area includes one or more of a top neighboring reconstructed area that is directly above the current block, a left neighboring reconstructed area that is directly to the left of the current block, a top-left neighboring reconstructed area, a top-right neighboring reconstructed area, and a bottom-left neighboring reconstructed area.

At (S2130), the filter is applied to the neighboring reconstructed area of the current block.

At (S2140), the current block is reconstructed according to the filtered neighboring reconstructed area.

Then, the process proceeds to (S2199) and terminates.

The process (2100) may be suitably adapted. Step(s) in the process (2100) may be modified and/or omitted. Additional step(s) may be added. Any suitable order of implementation may be used.

In an aspect, a method for video encoding includes determining whether to apply a filter to a neighboring reconstructed area of a current block in a current picture. The neighboring reconstructed area is adjacent to the current block and includes reconstructed samples in the current picture. The filter is applied to the neighboring reconstructed area of the current block and the current block is encoded according to the filtered neighboring reconstructed area. In an example, coded information of the current block is encoded in a video bitstream.

Benefits of the template filtering process described such as with references to FIGS. 8-10 and 21 for a template-based prediction mode are described below. For a template-based inter prediction mode, a misalignment arises between the current template that has not been filtered (e.g., has not been filtered using in-loop filter(s)) and the reference template that has been filtered (e.g., has been filtered using in-loop filter(s)). In some examples, this mismatch between the two templates undermines the accuracy of the template-based prediction mode that is based on a comparison of the two templates, leading to suboptimal coding efficiency. The template filtering process for the template-based inter prediction mode filters the current template, for example, with the filter(s) (e.g., including in-loop filter(s)), and thus may improve the accuracy of the template-based prediction mode that is based on the comparison of the two templates, leading to better coding efficiency.

In an aspect, a template-based intra prediction mode or a BV based prediction mode uses the current template to predict the current block, such as (i) using reconstructed samples in the current template to generate prediction samples of the current block, (ii) using the reconstructed samples in the current template in template searching to find a prediction block with at least one smallest template-matching cost, (iii) using the reconstructed samples in the current template to derive an intra prediction mode, and/or the like. Thus, by filtering the current template of the current block with filter(s) (e.g., in-loop filter(s)), the prediction of the current block may be more accurate.

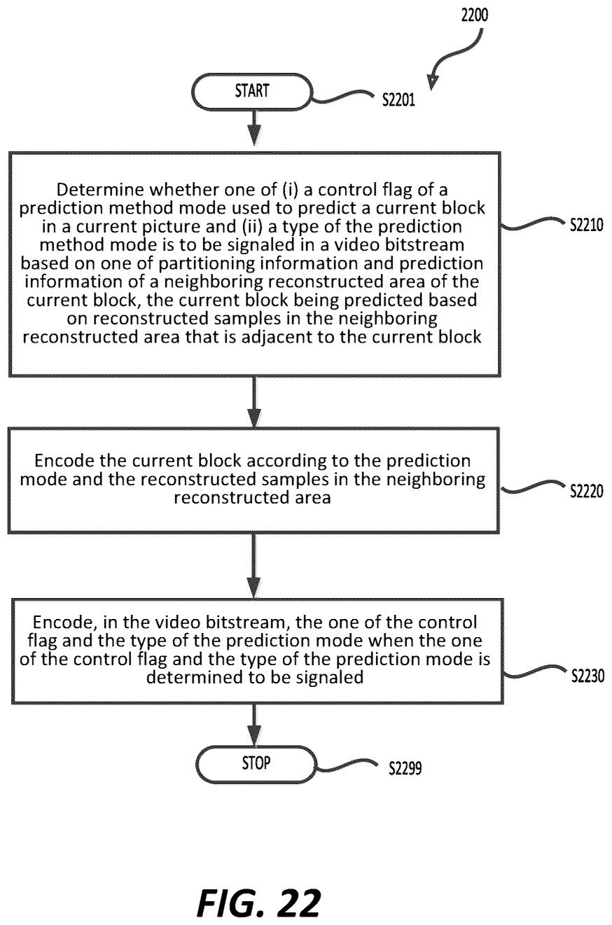

FIG. 22 shows a flow chart outlining a process (2200) according to an aspect of the disclosure. The process (2200) can be used in an apparatus, such as a video encoder. In various aspects, the process (2200) is executed by processing circuitry, such as the processing circuitry that performs functions of the video encoder (103), the processing circuitry that performs functions of the video encoder (303), and the like. In some aspects, the process (2200) is implemented in software instructions, thus when the processing circuitry executes the software instructions, the processing circuitry performs the process (2200). The process starts at (S2201) and proceeds to (S2210).

At (S2210), whether one of (i) a control flag of a prediction mode used to predict a current block in a current picture and (ii) a type of the prediction mode is to be signaled in a video bitstream is determined based on one of partitioning information and prediction information of a neighboring reconstructed area of the current block. The current block is predicted based on reconstructed samples in the neighboring reconstructed area that is adjacent to the current block.

In an example, whether the control flag of the prediction mode is to be signaled in the video bitstream is determined based on the partitioning information of the neighboring reconstructed area of the current block.

In an example, that the control flag of the prediction mode is to be signaled in the video bitstream is determined only when the partitioning information indicates that the reconstructed samples in the neighboring reconstructed area are from no more than N difference coding blocks.

In an example, when the control flag is determined to be signaled, an entropy context of the control flag is determined based on the partitioning information.

At (S2220), the current block is encoded according to the prediction mode and the reconstructed samples in the neighboring reconstructed area.

At (S2230), the one of the control flag and the type of the prediction mode is encoded in the video bitstream when the one of the control flag and the type of the prediction mode is determined to be signaled.

Then, the process proceeds to (S2299) and terminates.

The process (2200) may be suitably adapted. Step(s) in the process (2200) may be modified and/or omitted. Additional step(s) may be added. Any suitable order of implementation may be used.

In an example, the neighboring reconstructed area is determined to be used to predict the current block. The neighboring reconstructed area is signaled based on the partitioning information of the neighboring reconstructed area. In an example, the reconstructed samples in the neighboring reconstructed area are constrained to no more than N difference coding blocks.

In an example, a list (e.g., a template list) including a plurality of neighboring reconstructed areas that is adjacent to the current block is constructed based on respective partitioning information of the plurality of neighboring reconstructed areas. The plurality of neighboring reconstructed areas includes the neighboring reconstructed area. The neighboring reconstructed area is signaled based on a position of the neighboring reconstructed area in the list.

In an aspect, a method for video decoding includes determining whether one of (i) a control flag of a prediction mode used to predict a current block in a current picture and (ii) a type of the prediction mode is signaled in a video bitstream based on one of partitioning information and prediction information of a neighboring reconstructed area of the current block. The current block is predicted based on reconstructed samples in the neighboring reconstructed area that is adjacent to the current block. The current block is reconstructed according to the prediction mode and the reconstructed samples in the neighboring reconstructed area. In an example, the one of the control flag and the type of the prediction mode is decoded when the one of the control flag and the type of the prediction mode is signaled in the video bitstream.

Benefits of the control information signaling for coding tools that utilize decoder available reconstructed sample information such as described with references to FIGS. 11-12 and 22 are described below. For example, whether a control flag of a template-based mode is signaled, whether a template type is signaled, and/or a template-based method type is signaled is determined based on prediction information (such as partitioning information) of the current template of the current block. This is different from related technologies where the control flag is signaled (e.g., regardless of the partitioning information of the current block) and some syntax that represents specific template type is also signaled. Thus, the control information signaling that depends on the prediction information (such as partitioning information) of the current template of the current block may be more efficient, for example, under certain conditions, the control flag, the template type, and/or the template-based method type are not signaled, and thus reducing coding overhead.

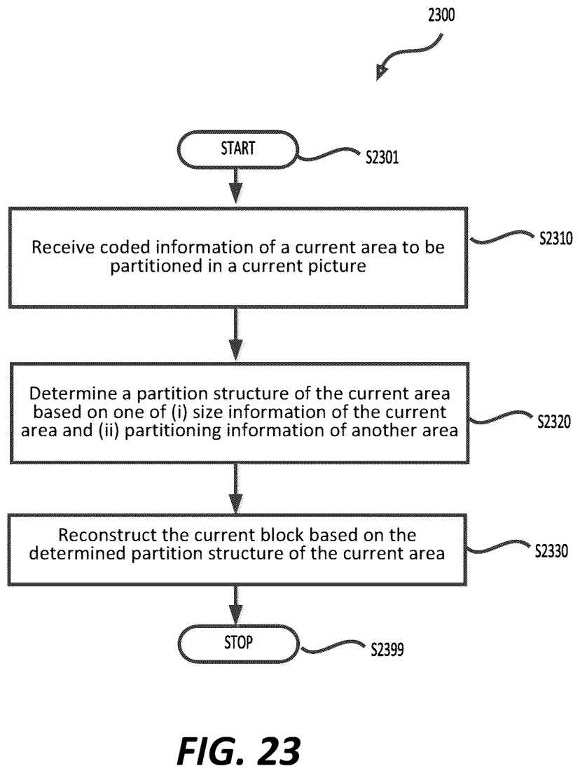

FIG. 23 shows a flow chart outlining a process (2300) according to an aspect of the disclosure. The process (2300) may be used in an apparatus, such as a video decoder. In various aspects, the process (2300) is executed by processing circuitry, such as the processing circuitry that performs functions of the video decoder (110), the processing circuitry that performs functions of the video decoder (210), and the like. In some aspects, the process (2300) is implemented in software instructions, thus when the processing circuitry executes the software instructions, the processing circuitry performs the process (2300). The process starts at (S2301) and proceeds to (S2310).

At (S2310), coded information of a current area to be partitioned in a current picture is received.

At (S2320), a partition structure of the current area is determined based on one of (i) size information of the current area and (ii) partitioning information of another area.

In an example, the current area and the other area have a same size, and the partition structure of the current area is determined as a partition structure of the other area.

At (S2330), the current area is reconstructed based on the determined partition structure of the current area.

Then, the process proceeds to (S2399) and terminates.

The process (2300) may be suitably adapted. Step(s) in the process (2300) may be modified and/or omitted. Additional step(s) may be added. Any suitable order of implementation may be used.

In an aspect, a method for video encoding includes determining a partition structure of the current area based on one of (i) size information of the current area and (ii) partitioning information of another area. The current area may be encoded based on the determined partition structure of the current area.

Benefits of the flexible partition split such as described with references to FIGS. 16-20 and 23 are described below. Unlike fixed partition splits that divide the current area in specific ways, the split regime (e.g., the way that sub-areas are generated) of the flexible partition split may be derived based on neighborhood information. Therefore, when flexible partition split is used, the partition regime may vary, and thus making the partition regime more versatile. In addition, since partition patterns may not need to be signaled, the signaling cost may be reduced.

In an aspect, a method of processing visual media data includes processing a video bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an aspect, the video bitstream includes coded information of a current block in a current picture. The format rules specifies that whether to apply a filter to a neighboring reconstructed area of the current block is determined. The neighboring reconstructed area is adjacent to the current block and including reconstructed samples in the current picture. The format rules specifies that the filter is applied to the neighboring reconstructed area of the current block and the current block is reconstructed according to the filtered neighboring reconstructed area.

In an aspect, the video bitstream includes coded information of a current block in a current picture. The format rules specifies that whether one of (i) a control flag of a prediction mode used to predict a current block in a current picture and (ii) a type of the prediction mode is signaled in the video bitstream is determined based on one of partitioning information and prediction information of a neighboring reconstructed area of the current block, the current block being predicted based on reconstructed samples in the neighboring reconstructed area that is adjacent to the current block. The format rule specifies that the current block is reconstructed according to the prediction mode and the reconstructed samples in the neighboring reconstructed area. The format rule specifies that the one of the control flag and the type of the prediction mode is decoded when the one of the control flag and the type of the prediction mode is signaled.

In an aspect, the video bitstream includes coded information of a current area to be partitioned in a current picture. The format rules specifies that a partition structure of the current area is determined based on one of (i) size information of the current area and (ii) partitioning information of another area and the current area is reconstructed based on the determined partition structure of the current area.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium. The disclosed methods may be used in various codecs (e.g., video codecs) such as the codecs described in the disclosure.

The processes (or methods) described in the disclosure may be implemented in an image and/or video decoding process or an image and/or video encoding process. The decoding/encoding process may be used in a video decoder device. The decoding/encoding process may be used in a video encoder device. In some examples, the process is executed by processing circuitry, such as the processing circuitry that performs functions of the video decoder, the processing circuitry that performs functions of the video decoder, and the like. In some examples, the process is executed by processing circuitry, such as the processing circuitry that performs functions of the video encoder, the processing circuitry that performs functions of the video encoder, and the like. In some examples, the process is implemented in software instructions, thus when the processing circuitry executes the software instructions, the processing circuitry performs the process. In some examples, the process may be implemented on the chip as a hardware process, thus when the processing circuitry executes the hardware instructions, the processing circuitry performs the process. The process may be suitably adapted. Steps in the process as described in the disclosure may be modified and/or omitted. Additional steps may be added. Any suitable order of implementation may be used.

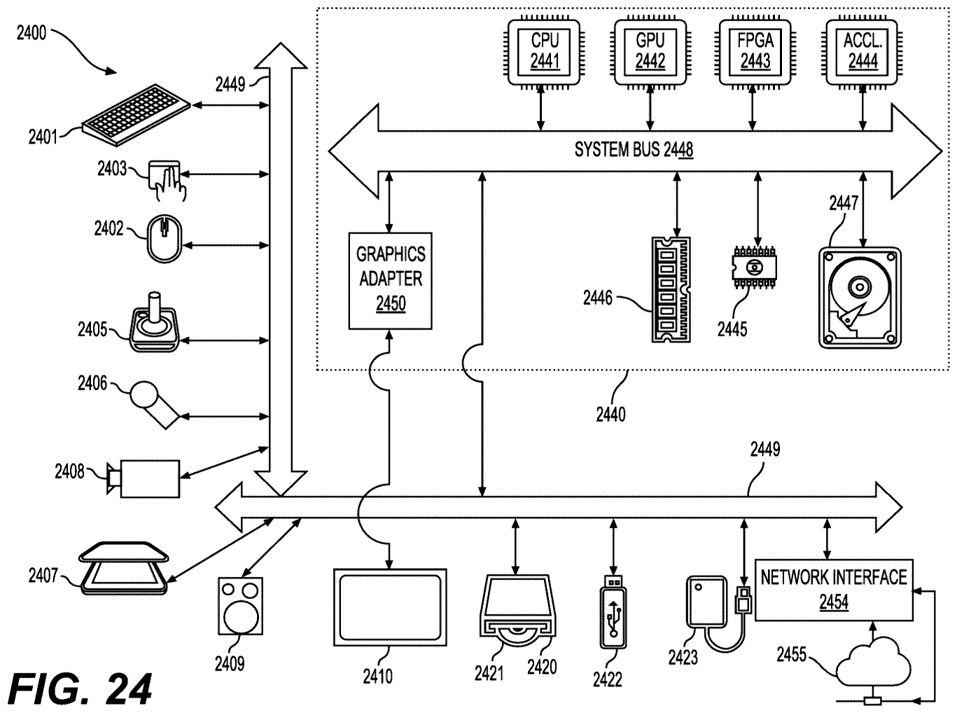

The techniques described above, may be implemented as computer software using computer-readable instructions and physically stored in one or more computer-readable media. For example, FIG. 24 shows a computer system (2400) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 24 for computer system (2400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (2400).

Computer system (2400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2401), mouse (2402), trackpad (2403), touch screen (2410), data-glove (not shown), joystick (2405), microphone (2406), scanner (2407), camera (2408).

Computer system (2400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2410), data-glove (not shown), or joystick (2405), but there may also be tactile feedback devices that do not serve as input devices), audio output devices (such as: speakers (2409), headphones (not depicted)), visual output devices (such as screens (2410) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2400) may also include human accessible storage devices and their associated media such as optical media including CD/DVD ROM/RW (2420) with CD/DVD or the like media (2421), thumb-drive (2422), removable hard drive or solid state drive (2423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2400) may also include an interface (2454) to one or more communication networks (2455). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2449) (such as, for example USB ports of the computer system (2400)); others are commonly integrated into the core of the computer system (2400) by attachment to a system bus as described below (for example Ethernet interface into a PC computer system or cellular network interface into a smartphone computer system). Using any of these networks, computer system (2400) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (2440) of the computer system (2400).

The core (2440) may include one or more Central Processing Units (CPU) (2441), Graphics Processing Units (GPU) (2442), specialized programmable processing units in the form of Field Programmable Gate Areas (FPGA) (2443), hardware accelerators for certain tasks (2444), graphics adapters (2450), and so forth. These devices, along with Read-only memory (ROM) (2445), Random-access memory (2446), internal mass storage such as internal non-user accessible hard drives, SSDs, and the like (2447), may be connected through a system bus (2448). In some computer systems, the system bus (2448) may be accessible in the form of one or more physical plugs to enable extensions by additional CPUs, GPU, and the like. The peripheral devices may be attached either directly to the core's system bus (2448), or through a peripheral bus (2449). In an example, the screen (2410) may be connected to the graphics adapter (2450). Architectures for a peripheral bus include PCI, USB, and the like.

CPUs (2441), GPUs (2442), FPGAs (2443), and accelerators (2444) may execute certain instructions that, in combination, may make up the aforementioned computer code. That computer code may be stored in ROM (2445) or RAM (2446). Transitional data may also be stored in RAM (2446), whereas permanent data may be stored for example, in the internal mass storage (2447). Fast storage and retrieve to any of the memory devices may be enabled through the use of cache memory, that may be closely associated with one or more CPU (2441), GPU (2442), mass storage (2447), ROM (2445), RAM (2446), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (2400), and specifically the core (2440) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (2440) that are of non-transitory nature, such as core-internal mass storage (2447) or ROM (2445). The software implementing various aspects of the present disclosure may be stored in such devices and executed by core (2440). A computer-readable medium may include one or more memory devices or chips, according to particular needs. The software may cause the core (2440) and specifically the processors therein (including CPU, GPU, FPGA, and the like) to execute particular processes or particular parts of particular processes described herein, including defining data structures stored in RAM (2446) and modifying such data structures according to the processes defined by the software. In addition or as an alternative, the computer system may provide functionality as a result of logic hardwired or otherwise embodied in a circuit (for example: accelerator (2444)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for video decoding, the method including: receiving coded information of a current block in a current picture; determining whether to apply a filter to a neighboring reconstructed area of the current block, the neighboring reconstructed area being adjacent to the current block and including reconstructed samples in the current picture; applying the filter to the neighboring reconstructed area of the current block; and reconstructing the current block according to the filtered neighboring reconstructed area.
(2) The method of feature (1), in which the filter includes one or more in-loop filters.
(3) The method of feature (2), in which the one or more in-loop filters include one or more of (i) a deblocking filter, (ii) a sample adaptive offset (SAO), (iii) a bilateral filter, and (iv) an adaptive loop filter (ALF).
(4) The method of any one of features (1)-(3), in which the determining whether to apply the filter includes: determining to apply a deblocking filter when an edge is detected in the neighboring reconstructed area, the filter including the deblocking filter.
(5) The method of feature (4), in which the edge is detected in the neighboring reconstructed area, the deblocking filter is a horizontal deblocking filter when the edge is a vertical edge, and the deblocking filter is a vertical deblocking filter when the edge is a horizontal edge.
(6) The method of feature any one of features (1)-(3), in which the determining whether to apply the filter comprises determining whether to apply the filter based on coding information of the neighboring reconstructed area.
(7) The method of feature (6), in which the coding information includes partitioning information; the partitioning information indicates that the neighboring reconstructed area includes reconstructed samples from a plurality of coded blocks in the current picture, the plurality of coded blocks forms at least one coded block boundary in the neighboring reconstructed area, each of the at least one coded block boundary is between two adjacent coded blocks in the plurality of coded blocks; and the determining whether to apply the filter includes determining that the filter is only applied to the reconstructed samples adjacent to the at least one coded block boundary.
(8) The method of any one of features (1)-(7), in which a minimum of a width and a height of the neighboring reconstructed area is at least 4 samples.
(9) The method of any one of features (1)-(8), in which the neighboring reconstructed area includes one or more of a top neighboring reconstructed area that is directly above the current block, a left neighboring reconstructed area that is directly to the left of the current block, a top-left neighboring reconstructed area, a top-right neighboring reconstructed area, and a bottom-left neighboring reconstructed area.
(10) The method of any one of features (1)-(9), in which the current block is coded using inter prediction, and the neighboring reconstructed area is a current template of the current block.
(11) The method of any one of features (1)-(9), in which the current block is coded using one of (i) intra prediction and (ii) a block vector (BV) based prediction mode.
(12) A method for video encoding, the method including: determining whether one of (i) a control flag of a prediction mode used to predict a current block in a current picture and (ii) a type of the prediction mode is to be signaled in a video bitstream based on one of partitioning information and prediction information of a neighboring reconstructed area of the current block, the current block being predicted based on reconstructed samples in the neighboring reconstructed area that is adjacent to the current block; encoding the current block according to the prediction mode and the reconstructed samples in the neighboring reconstructed area; and encoding, in the video bitstream, the one of the control flag and the type of the prediction mode when the one of the control flag and the type of the prediction mode is determined to be signaled.
(13) The method of feature (12), in which the determining includes: determining whether the control flag of the prediction mode is to be signaled in the video bitstream based on the partitioning information of the neighboring reconstructed area of the current block.
(14) The method of feature (13), in which the determining includes: determining that the control flag of the prediction mode is to be signaled in the video bitstream only when the partitioning information indicates that the reconstructed samples in the neighboring reconstructed area are from no more than N difference coding blocks.
(15) The method of feature (13) or (14), in which the method further includes when the control flag is determined to be signaled, determining an entropy context of the control flag based on the partitioning information.
(16) The method of feature (12), in which the method includes determining that the neighboring reconstructed area is to be used to predict the current block; and signaling the neighboring reconstructed area based on the partitioning information of the neighboring reconstructed area.
(17) The method of feature (16), in which the reconstructed samples in the neighboring reconstructed area are constrained to no more than N difference coding blocks.
(18) The method of feature (16), in which the method includes constructing a list including a plurality of neighboring reconstructed areas that is adjacent to the current block based on respective partitioning information of the plurality of neighboring reconstructed areas, the plurality of neighboring reconstructed areas including the neighboring reconstructed area; and the signaling the neighboring reconstructed area includes signaling the neighboring reconstructed area based on a position of the neighboring reconstructed area in the list.
(19) A method for video decoding, the method including: receiving coded information of a current area to be partitioned in a current picture; determining a partition structure of the current area based on one of (i) size information of the current area and (ii) partitioning information of another area; and reconstructing the current area based on the determined partition structure of the current area.
(20) The method of feature (19), in which the current area and the other area have a same size; and the determining includes determining the partition structure of the current area as a partition structure of the other area.
(21) An apparatus for decoding, including processing circuitry that is configured to perform the method of any of features (1) to (11).
(22) An apparatus for encoding, including processing circuitry that is configured to perform the method of any of features (12) to (18).
(23) An apparatus for decoding, including processing circuitry that is configured to perform the method of any of features (19) to (20).
(24) A non-transitory computer-readable storage medium storing instructions which when executed by at least one processor cause the at least one processor to perform the method of any of features (1) to (20).

What is claimed is:

1. A method for video decoding, the method comprising:
receiving coded information of a current block in a current picture;
determining whether to apply a filter to a neighboring reconstructed area of the current block, the neighboring reconstructed area being adjacent to the current block and including reconstructed samples in the current picture;
applying the filter to the neighboring reconstructed area of the current block; and
reconstructing the current block according to the filtered neighboring reconstructed area.

2. The method of claim 1, wherein the filter includes one or more in-loop filters.

3. The method of claim 2, wherein the one or more in-loop filters include one or more of (i) a deblocking filter, (ii) a sample adaptive offset (SAO), (iii) a bilateral filter, and (iv) an adaptive loop filter (ALF).

4. The method of claim 1, wherein the determining whether to apply the filter comprises:
determining to apply a deblocking filter when an edge is detected in the neighboring reconstructed area, the filter including the deblocking filter.

5. The method of claim 4, wherein
the edge is detected in the neighboring reconstructed area,
the deblocking filter is a horizontal deblocking filter when the edge is a vertical edge, and
the deblocking filter is a vertical deblocking filter when the edge is a horizontal edge.

6. The method of claim 1, wherein the determining whether to apply the filter comprises:
determining whether to apply the filter based on coding information of the neighboring reconstructed area.

7. The method of claim 6, wherein
the coding information includes partitioning information;
the partitioning information indicates that the neighboring reconstructed area includes reconstructed samples from a plurality of coded blocks in the current picture, the plurality of coded blocks forms at least one coded block boundary in the neighboring reconstructed area, each of the at least one coded block boundary is between two adjacent coded blocks in the plurality of coded blocks; and
the determining whether to apply the filter includes determining that the filter is only applied to the reconstructed samples adjacent to the at least one coded block boundary.

8. The method of claim 1, wherein a minimum of a width and a height of the neighboring reconstructed area is at least 4 samples.

9. The method of claim 1, wherein the neighboring reconstructed area includes one or more of a top neighboring reconstructed area that is directly above the current block, a left neighboring reconstructed area that is directly to the left of the current block, a top-left neighboring reconstructed area, a top-right neighboring reconstructed area, and a bottom-left neighboring reconstructed area.

10. The method of claim 1, wherein the current block is coded using inter prediction, and the neighboring reconstructed area is a current template of the current block.

11. The method of claim 1, wherein the current block is coded using one of (i) intra prediction and (ii) a block vector (BV) based prediction mode.

12. A method for video encoding, the method comprising:
determining whether one of (i) a control flag of a prediction mode used to predict a current block in a current picture and (ii) a type of the prediction mode is to be signaled in a video bitstream based on one of partitioning information and prediction information of a neighboring reconstructed area of the current block, the current block being predicted based on reconstructed samples in the neighboring reconstructed area that is adjacent to the current block;
encoding the current block according to the prediction mode and the reconstructed samples in the neighboring reconstructed area; and
encoding, in the video bitstream, the one of the control flag and the type of the prediction mode when the one of the control flag and the type of the prediction mode is determined to be signaled.

13. The method of claim 12, wherein the determining comprises:
determining whether the control flag of the prediction mode is to be signaled in the video bitstream based on the partitioning information of the neighboring reconstructed area of the current block.

14. The method of claim 13, wherein the determining comprises:
determining that the control flag of the prediction mode is to be signaled in the video bitstream only when the partitioning information indicates that the reconstructed samples in the neighboring reconstructed area are from no more than N difference coding blocks.

15. The method of claim 13, further comprising:
when the control flag is determined to be signaled, determining an entropy context of the control flag based on the partitioning information.

16. The method of claim 12, further comprising:
determining that the neighboring reconstructed area is to be used to predict the current block; and
signaling the neighboring reconstructed area based on the partitioning information of the neighboring reconstructed area.

17. The method of claim 16, wherein the reconstructed samples in the neighboring reconstructed area are constrained to no more than N difference coding blocks.

18. The method of claim 16, wherein
the method includes constructing a list including a plurality of neighboring reconstructed areas that is adjacent to the current block based on respective partitioning information of the plurality of neighboring reconstructed areas, the plurality of neighboring reconstructed areas including the neighboring reconstructed area; and
the signaling the neighboring reconstructed area includes signaling the neighboring reconstructed area based on a position of the neighboring reconstructed area in the list.

19. A method for video decoding, the method comprising:
receiving coded information of a current area to be partitioned in a current picture;
determining a partition structure of the current area based on one of (i) size information of the current area and (ii) partitioning information of another area; and
reconstructing the current area based on the determined partition structure of the current area.

20. The method of claim 19, wherein
the current area and the other area have a same size; and
the determining includes determining the partition structure of the current area as a partition structure of the other area.
